(19) United States
(12) Patent Application Publication
(10) Pub. No.: US 2026/0367893 A1
(43) Pub. Date: Nov. 19, 2026

(54) EFFICIENT BUILD-TIME NEURAL NETWORK ACCELERATOR TASK DESCRIPTION GENERATION

(71) Applicants: Gleb Gladilov, Lucan (IE); Chunyun Wang, Beijing (CN); Lulin Deng, Shanghai (CN)

(72) Inventors: Gleb Gladilov, Lucan (IE); Chunyun Wang, Beijing (CN); Lulin Deng, Shanghai (CN)

(73) Assignee: Intel Products IP LLC, Santa Clara, CA (US)

(21) Appl. No.: 19/722,772

(22) Filed: Jun. 27, 2026

Related U.S. Application Data
(60) Provisional application No. 63/895,137, filed on Oct. 7, 2025.

(51) Int. Cl. G06F 8/41; G06F 9/50

(52) U.S. Cl. CPC G06F 8/441; G06F 9/5027

(57) ABSTRACT

An accelerator compiler may generate task descriptors for hardware engines that perform neural network execution. In a compiler build-time phase, descriptor definitions for the task descriptors may be used to generate computer-usable code that encodes layout information for fields of the task descriptors. In a model compile-time phase, the generated computer-usable code can be used to populate a task descriptor for a scheduled task by writing one or more values into one or more fields of the task descriptor according to the encoded layout information. The encoded layout information may identify where values are to be written in the task descriptor, which can reduce or eliminate repeated searches of generic descriptor representations for field locations during model compilation. The populated task descriptor may be included in a binary artifact usable by the accelerator hardware to perform at least a portion of the neural network execution.

### PRIORITY APPLICATION

This patent application claims priority to and/or receives benefit from U.S. Provisional Application No. 63/895,137, filed on Oct. 7, 2025, titled “APPARATUS AND METHOD FOR EFFICIENT BUILD-TIME TASK DESCRIPTION GENERATION” (Docket No. AG7757-Z). The U.S. Provisional Application is hereby incorporated by reference in its entirety.

### BACKGROUND

Neural network (NN) accelerators may include hardware engines that perform tasks associated with neural network execution. A compiler can generate a binary artifact, sometimes referred to as a blob, that is usable by the accelerator to perform at least a portion of the neural network execution. The binary artifact may comprise task descriptors for scheduled tasks, and each task descriptor may specify one or more values used by a corresponding hardware engine when performing a task.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates a computing system having a compiler and a neural network hardware accelerator, according to some examples of the disclosure.

FIG. 2 depicts pseudocode illustrating a conventional process for generating task descriptors.

FIG. 3 illustrates a build-time engine, according to some examples of the disclosure.

FIG. 4 depicts a reusable blueprint, according to some examples of the disclosure.

FIG. 5 depicts a write field function, according to some examples of the disclosure.

FIG. 6 depicts an example declarative descriptor type D, according to some examples of the disclosure.

FIG. 7 depicts generated computer-usable code having layout information for the declarative descriptor type D, according to some examples of the disclosure.

FIG. 8 illustrates a compile-time engine, according to some examples of the disclosure.

FIG. 9 depicts pseudocode illustrating populating a task descriptor, according to some examples of the disclosure.

FIG. 10 is a flow diagram illustrating a method for efficient generation of task descriptors usable by an accelerator, according to some examples of the disclosure.

FIG. 11 depicts a block diagram of an exemplary computing device, according to some examples of the disclosure.

### DETAILED DESCRIPTION

### Overview

Existing accelerator compilers may spend significant time generating task descriptors for neural network execution. A task descriptor can comprise many fields that specify how a hardware engine of an accelerator is to perform a scheduled task. In a generic descriptor representation, a compiler may need to perform lookup operations during descriptor population to determine where values are to be written in the task descriptor. When a neural network execution involves many scheduled tasks and many descriptor fields, repeated lookup operations can increase compilation latency and make descriptor population more error-prone.

To address this issue, descriptor layout processing can be separated or decoupled from task descriptor population. Based on one or more descriptor definitions for one or more task descriptors, computer-usable code is generated that encodes layout information of one or more fields of the task descriptors. The task descriptors may be usable by one or more hardware engines of an accelerator to perform one or more tasks associated with neural network execution. During model compilation, the generated computer-usable code is used to populate a task descriptor for a scheduled task in a memory location by writing one or more values into one or more fields of the task descriptor according to the encoded layout information.

The descriptor definitions provide a structured and declarative description of the task descriptor layouts used by the accelerator hardware. In some examples, the descriptor definitions define a hierarchy in which a given task descriptor has one or more registers and a register has a plurality of fields. The generated computer-usable code can reflect this hierarchy by generating one or more data types corresponding to one or more of a descriptor type, a register type, or a field type. This allows descriptor layout knowledge to be represented in code that can be used directly by compiler passes that populate task descriptors.

The layout information encoded by the generated computer-usable code may comprise, for a field of the task descriptor, one or more of a bit offset, a byte offset, a field width, a field type, or a register identifier. By encoding this information ahead of descriptor population, the compiler can identify where a value is to be written without performing, during the populating, a lookup operation to determine the write location. This contrasts with generic representations that may require a search through maps, field names, or descriptor structures at the time each value is written.

In some examples, populating the task descriptor comprises invoking a write function parameterized by a descriptor type and a field type. The descriptor type can identify the task descriptor being populated, and the field type can identify the field into which a value is to be written. Because the field type can encode layout information, the write function can use that information to determine how to write the value to the memory location associated with the task descriptor.

In some examples, the write function may include a compile-time check that verifies that a field type is associated with a descriptor type. This can help detect invalid descriptor-field combinations before the compiler is used to compile neural network models. For example, if a field type associated with one task descriptor is incorrectly used with another descriptor type, the compile-time check can produce an error during software construction rather than allowing the error to appear during model compilation or accelerator execution.

The generated computer-usable code can also support efficient bit-level updates. In some examples, writing a value comprises determining, based on the encoded layout information, a storage word and a bit position corresponding to a field of the task descriptor, and updating one or more bits of the storage word corresponding to the field.

This allows a compiler pass to update a specific field while preserving neighboring fields in the same storage word.

The approach can support different hardware engine descriptor formats. For example, the one or more task descriptors may comprise one or more compute task descriptors usable by a compute engine of the accelerator and one or more copy task descriptors usable by a copy engine of the accelerator. The same general generation and population process can be applied even when compute task descriptors and copy task descriptors have different field layouts.

The approach can also support accelerator-configuration-specific descriptor layouts. In some examples, the descriptor definitions identify a descriptor layout associated with a particular accelerator configuration, and the generated computer-usable code encodes the descriptor layout associated with that particular accelerator configuration. The descriptor layout may be selected from a plurality of descriptor layouts associated with different accelerator configurations before generating the computer-usable code, allowing the compiler infrastructure to account for differences among accelerator generations or product configurations.

After population, a binary artifact may be generated that comprises the task descriptor populated using the generated computer-usable code. The binary artifact can be usable by the accelerator to perform at least a portion of the neural network execution. The populated task descriptor can specify how a corresponding hardware engine is to perform a scheduled task, such as a compute task or a copy task, during execution of the compiled neural network workload.

Although some examples are described in the context of neural network execution on an accelerator, the same organization may be applied to compilers or code-generation systems that populate hardware-consumable descriptors having defined field layouts. For example, the descriptor definitions may describe task descriptors for one or more of a neural processing unit, graphics processing unit, tensor processing unit, digital signal processor, field-programmable gate array, application-specific integrated circuit, direct memory access engine, cryptographic accelerator, video encoder, video decoder, image signal processor, network packet processing engine, storage controller, or radio frequency processing engine. In such examples, the generated computer-usable code may encode layout information for fields of descriptors usable by the corresponding hardware engines, and a compiler, driver, firmware tool, runtime, or build system may populate the descriptors by writing values into fields according to the encoded layout information. The descriptor definitions, generated computer-usable code, and descriptor population operations may also be adapted to different accelerator configurations, different hardware engines, different descriptor hierarchies, and different descriptor formats, including compute descriptors, copy descriptors, command descriptors, control descriptors, data movement descriptors, packet descriptors, frame descriptors, or firmware command descriptors.

One or more technical advantages can arise from moving descriptor layout resolution out of the repeated task descriptor population path and into generated computer-usable code. In a compiler that populates many task descriptors for a neural network execution, descriptor population may be performed many times across scheduled tasks, hardware engines, and descriptor fields. If the compiler determines a write location by performing a lookup operation each time a field is populated, the compiler repeatedly expends processor cycles and memory bandwidth on operations that do not generate the descriptor value itself, such as searching a descriptor representation, comparing field identifiers, resolving a field location, and updating a generic descriptor object. By generating computer-usable code that encodes layout information of fields of task descriptors, such as one or more of a bit offset, a byte offset, a field width, a field type, or a register identifier, the compiler can convert descriptor population from a repeated field location discovery process into an offset-based memory update. This changes how the compiler uses computing resources during model compilation, because the compiler can write values into fields of a task descriptor according to layout information already represented in the generated computer-usable code.

In some examples, this can improve model compilation latency in a manner that scales with descriptor count and field count. A neural network execution can require many scheduled tasks, and each scheduled task may have a task descriptor having many fields. Avoiding a lookup operation during population of each field can reduce the number of repeated searches, comparisons, indirections, and temporary updates performed by the compiler. The benefit can be especially significant when the accelerator uses multiple hardware engine descriptor formats, such as compute task descriptors usable by compute engines and copy task descriptors usable by copy engines, because each descriptor format can have its own layout while still being populated through generated computer-usable code that encodes the corresponding layout information.

In some examples, the generated computer-usable code can comprise generated data types corresponding to one or more of a descriptor type, a register type, or a field type. These generated data types can provide a machine-checkable representation of the descriptor hierarchy in which a given task descriptor has one or more registers and a register has a plurality of fields. A write function parameterized by a descriptor type and a field type can use the generated data types to specialize descriptor population for a particular descriptor-field combination. This can allow layout parameters to be resolved through compiled code rather than through runtime descriptor traversal, improving instruction locality and reducing branch-heavy or data-dependent lookup behavior during model compilation.

In some examples, the write function can include a compile-time check that verifies that a field type is associated with a descriptor type. This can provide a reliability improvement beyond ordinary performance optimization. A descriptor-field mismatch can be detected while compiler software is built or validated, before the compiler generates a binary artifact for accelerator execution. As a result, errors such as writing a value intended for one descriptor format into a field of another descriptor format may be caught before an invalid task descriptor is placed into a binary artifact. This can improve the correctness of accelerator-consumable outputs and reduce failures that would be harder to diagnose after model compilation or during accelerator execution.

In some examples, the encoded layout information can also improve the precision of memory updates used to form a task descriptor. For example, the compiler can determine, based on the generated computer-usable code, a storage word and a bit position corresponding to a field of the task descriptor, and can update one or more bits of the storage word corresponding to the field. This can enable a value to be written into a target field while preserving adjacent fields in the same storage word. Such bit-field updates can reduce unnecessary rewriting of descriptor data and can help maintain descriptor correctness when multiple fields share a register or storage word.

In some examples, generating computer-usable code for a descriptor layout associated with a particular accelerator configuration can improve portability and maintainability of the compiler across accelerator configurations. Descriptor definitions can identify the descriptor layout for a selected accelerator configuration, and the generated computer-usable code can encode that selected layout. This allows the compiler to populate task descriptors according to the actual layout used by the hardware engines of that accelerator configuration, while reducing manually maintained field location code that may become inconsistent with hardware descriptor definitions. The populated task descriptors can be included in a binary artifact usable by the accelerator to perform at least a portion of the neural network execution.

As used herein, “accelerator” can refer to hardware, circuitry, logic, processing resources, or any combination thereof that can perform one or more operations associated with a workload. In some examples, an accelerator can comprise one or more hardware engines for performing one or more tasks associated with neural network execution. Examples of accelerators can include a neural processing unit, graphics processing unit, tensor processing unit, artificial intelligence accelerator, machine learning accelerator, digital signal processor, field-programmable gate array, application-specific integrated circuit, or any combination thereof.

As used herein, “hardware engine” can refer to a hardware component, circuit, processing block, execution unit, module, or logic configured to perform one or more tasks using a task descriptor. In some examples, a hardware engine can comprise one or more of a compute engine, a copy engine, a fixed-function engine, a programmable engine, a matrix multiplication engine, a convolution engine, a data movement engine, a direct memory access engine, or a post-processing engine.

As used herein, “task descriptor” can refer to data usable by a hardware engine to perform a task. In some examples, a task descriptor can comprise one or more values, fields, registers, control parameters, configuration parameters, memory addresses, dimensions, modes, strides, operation identifiers, or scheduling information. A task descriptor can be stored in memory, included in a binary artifact, or provided to an accelerator for neural network execution.

As used herein, “descriptor definition” can refer to information that describes a layout, structure, organization, field arrangement, field relationship, or encoding of a task descriptor. In some examples, a descriptor definition can identify one or more of a descriptor type, a register type, a field type, a bit offset, a byte offset, a field width, a register identifier, a field identifier, or a relationship among descriptors, registers, and fields.

As used herein, “computer-usable code” can refer to code, data, declarations, metadata, instructions, definitions, source code, header code, intermediate code, generated code, template code, configuration code, or any combination thereof that can be used by a computer, compiler, build system, software tool, or processor. In some examples, computer-usable code can encode layout information for one or more fields of one or more task descriptors.

As used herein, “generated computer-usable code” can refer to computer-usable code produced based on one or more descriptor definitions and usable by a compiler, build system, software tool, processor, or computer system. In some examples, generated computer-usable code can comprise source code, header code, generated declarations, generated data types, generated templates, intermediate code, object code, compiled binary code, executable code, library code, machine code, bytecode, metadata compiled into a binary, or any combination thereof. In some examples, generated computer-usable code can encode layout information of one or more fields of one or more task descriptors, such as one or more of a bit offset, a byte offset, a field width, a field type, or a register identifier.

As used herein, “layout information” can refer to information indicating how one or more portions of a task descriptor are arranged, addressed, encoded, accessed, or written. In some examples, layout information can comprise, for a field of a task descriptor, one or more of a bit offset, a byte offset, a field width, a field type, a register identifier, a descriptor identifier, an alignment, a storage word identifier, a bit position, a mask, a shift value, or a value encoding rule.

As used herein, “field” can refer to a portion of a task descriptor that can store, represent, or encode a value used by a hardware engine. In some examples, a field can comprise one or more bits, bytes, words, registers, or sub-portions of a register. A field can correspond to one or more of a control parameter, configuration value, mode value, operation value, dimension value, stride value, memory address value, pointer value, or scheduling value.

As used herein, “register” can refer to a storage element, logical grouping, memory word, hardware register, software-defined register representation, or descriptor portion that has one or more fields. In some examples, a register of a task descriptor can comprise a plurality of fields, and the fields can have respective bit positions and field widths within the register.

As used herein, “descriptor type,” “register type,” and “field type” can refer to generated or defined data types, classes, structures, templates, aliases, metadata entries, or code representations associated with a task descriptor, register, or field, respectively. In some examples, a field type can encode layout information of a corresponding field, and a descriptor type can identify one or more register types or field types associated with a task descriptor.

As used herein, “populating a task descriptor” can refer to writing, storing, inserting, updating, encoding, setting, or placing one or more values into one or more fields of the task descriptor. In some examples, populating a task descriptor can comprise writing one or more values to a memory location according to layout information encoded by generated computer-usable code.

As used herein, “lookup operation” can refer to an operation that searches, queries, indexes, traverses, compares, or resolves information to determine where a value is to be written in a task descriptor. In some examples, a lookup operation can comprise one or more of a field-name lookup, descriptor-name lookup, string comparison, map lookup, tree lookup, table lookup, hash lookup, database lookup, or traversal of a generic descriptor representation.

As used herein, “scheduled task” can refer to a task selected, ordered, assigned, allocated, or arranged for execution by one or more hardware engines of an accelerator. In some examples, a scheduled task can correspond to one or more operations associated with neural network execution, such as a compute operation, copy operation, matrix multiplication operation, convolution operation, activation operation, data movement operation, memory transfer operation, or post-processing operation.

As used herein, “memory location” can refer to any storage location, address, buffer, word, region, object, allocation, data structure, or storage area at which a task descriptor or portion of a task descriptor can be stored or updated. In some examples, a memory location can be in system memory, local memory, compiler-managed memory, an output buffer, an intermediate representation, a binary artifact, or memory accessible to an accelerator.

As used herein, “binary artifact” can refer to a blob, compiled output, executable artifact, data file, binary file, firmware-consumable artifact, accelerator-consumable artifact, or any combination thereof that can comprise one or more populated task descriptors. In some examples, a binary artifact can be usable by an accelerator to perform at least a portion of neural network execution.

As used herein, “accelerator configuration” can refer to a hardware configuration, product configuration, generation, engine arrangement, descriptor format, target architecture, or implementation profile associated with an accelerator. In some examples, an accelerator configuration can identify one or more of a number of compute modules, a number of compute engines, a number of copy engines, descriptor layouts, register layouts, field layouts, supported operations, or hardware generation information.

### Computing System for Generating Accelerator Task Descriptors

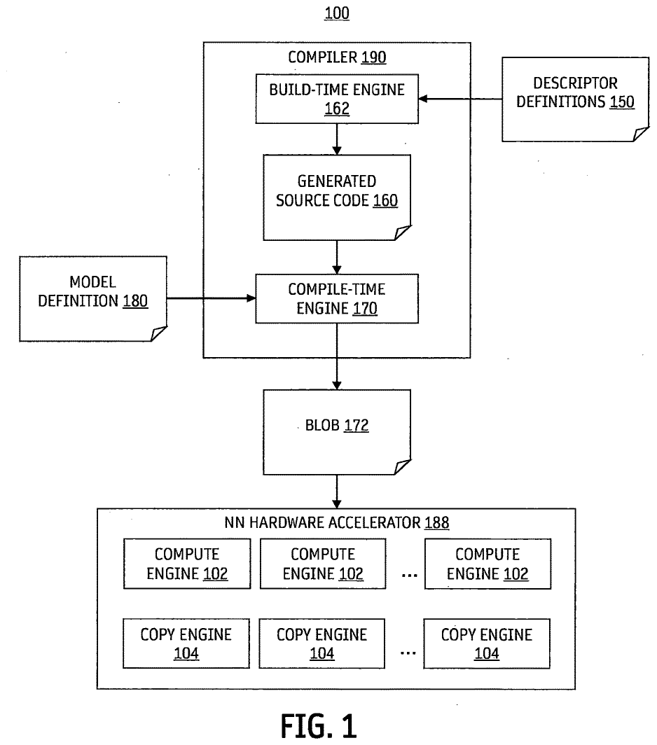

FIG. 1 illustrates computing system 100 having compiler 190 and NN hardware accelerator 188, according to some examples of the disclosure. Compiler 190 can generate blob 172 based on model definition 180 and descriptor definitions 150. Blob 172 can comprise one or more task descriptors usable by NN hardware accelerator 188 to perform one or more tasks associated with neural network execution.

Descriptor definitions 150 can comprise one or more declarative, semantic, or machine-readable descriptions of task descriptors usable by one or more hardware engines of NN hardware accelerator 188. Descriptor definitions 150 may describe descriptor structure at a level that is independent of code used by compile-time engine 170 to populate task descriptors. For example, descriptor definitions 150 may identify one or more descriptor kinds, registers, fields, field names, field relationships, field sizes, field ordering, supported accelerator configurations, hardware engine associations, or any combination thereof. Build-time engine 162 can process descriptor definitions 150 to generate generated source code 160 that encodes layout information usable during descriptor population.

Compiler 190 can comprise build-time engine 162 and compile-time engine 170.

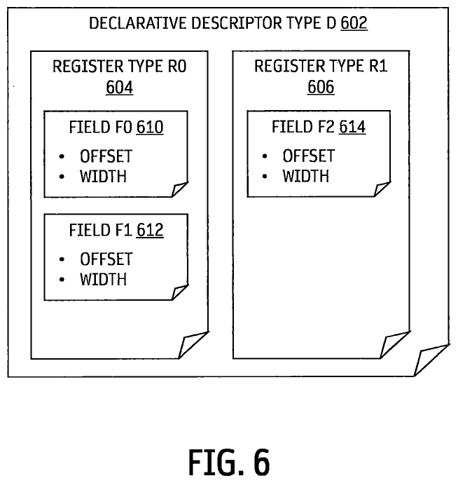

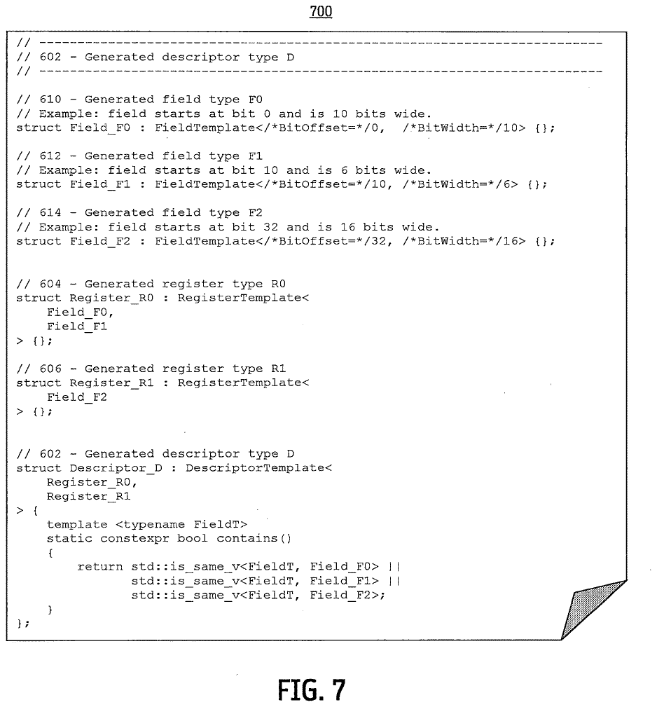

Build-time engine 162 can generate generated source code 160 based on descriptor definitions 150. Generated source code 160 can be an example of generated computer-usable code produced from a declarative, semantic, or machine-readable description of task descriptor structure. In some examples, generated source code 160 may translate information from descriptor definitions 150 into code-level representations that can be used by compile-time engine 170 to populate task descriptors. For example, generated source code 160 may comprise one or more of generated declarations, generated constants, generated data types, generated templates, generated structures, generated metadata, generated access functions, or generated layout descriptors. Generated source code 160 can encode layout information of one or more fields of one or more task descriptors, such as one or more of a bit offset, a byte offset, a field width, a field type, a register identifier, a descriptor identifier, a storage word identifier, or a bit position. In some examples, generated source code 160 may comprise one or more generated data types corresponding to one or more of a descriptor type, a register type, or a field type, as illustrated in FIGS. 6 and 7. Generated source code 160 can allow compile-time engine 170 to write values into fields of task descriptors according to encoded layout information rather than determining field locations through a lookup operation during descriptor population.

Model definition 180 can describe a neural network model to be compiled for execution by NN hardware accelerator 188. Model definition 180 may comprise one or more of a neural network graph, an intermediate representation, a model file, model parameters, model weights, tensor definitions, operator definitions, layer definitions, execution constraints, or compiler metadata. In some examples, model definition 180 can correspond to a computer-vision model, speech-processing model, audio-processing model, generative model, transformer model, recommendation model, image processing model, or natural-language-processing model. For example, model definition 180 may describe one or more of a convolutional neural network for image classification, an object-detection network for camera input, a segmentation network for image processing, a transformer model for language processing, an encoder-decoder model for speech recognition, a diffusion model for image generation, or a recommendation model for ranking candidate items. Model definition 180 can be provided to compile-time engine 170, and compile-time engine 170 can compile model definition 180 into one or more scheduled tasks having task descriptors for execution by NN hardware accelerator 188.

Compile-time engine 170 can use generated source code 160 to populate one or more task descriptors for one or more scheduled tasks of model definition 180. In some examples, compile-time engine 170 can perform a model compile-time phase after build-time engine 162 has produced generated source code 160. During the model compile-time phase, compile-time engine 170 can process model definition 180 to determine one or more scheduled tasks to be performed by NN hardware accelerator 188. For a scheduled task, compile-time engine 170 can determine one or more values to be written into a corresponding task descriptor. Such values may represent one or more of an operation type, tensor dimension, tile size, stride, memory address, buffer identifier, data format, activation mode, post-processing mode, copy size, source address, destination address, or hardware engine control value.

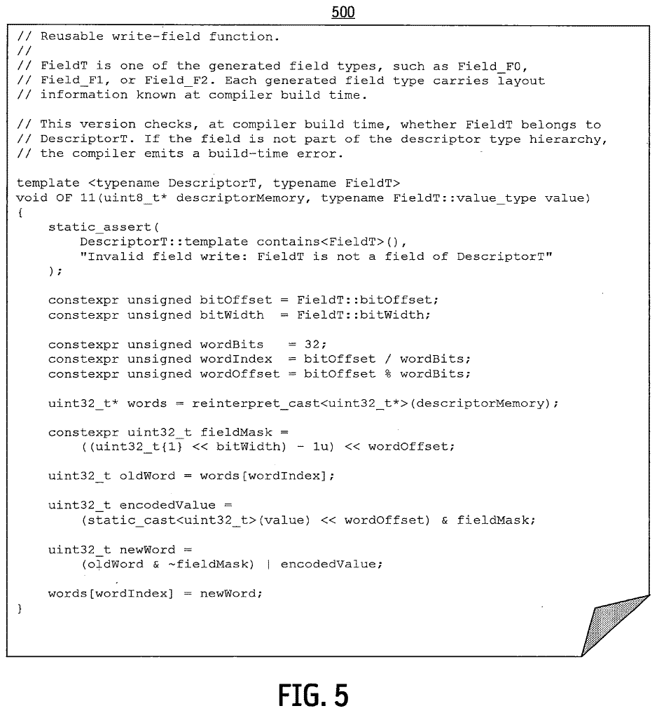

Compile-time engine 170 can populate a task descriptor for a scheduled task in a memory location by writing, to the memory location, one or more values into one or more fields of the task descriptor according to layout information encoded by generated source code 160. For example, generated source code 160 may indicate that a particular field of the task descriptor has a bit offset, byte offset, field width, field type, register identifier, storage word identifier, bit position, or any combination thereof. Compile-time engine 170 can use that encoded layout information to determine where and how a value is to be written in the task descriptor. In some examples, compile-time engine 170 may invoke a write function parameterized by a descriptor type and a field type, as illustrated in FIG. 5. The descriptor type and field type may correspond to generated data types of generated source code 160, as illustrated in FIGS. 6 and 7.

In some examples, compile-time engine 170 can populate the task descriptor without performing, during the populating, a lookup operation to determine where the one or more values are to be written in the task descriptor. For example, compile-time engine 170 may avoid one or more of a field-name lookup, descriptor-name lookup, string comparison, map lookup, tree lookup, table lookup, hash lookup, or traversal of a generic descriptor representation during population of the task descriptor. Instead, generated source code 160 can provide layout information that allows compile-time engine 170 to perform offset-based, type-based, or bit-position-based writes to the memory location. In some examples, compile-time engine 170 can determine, based on layout information encoded by generated source code 160, a storage word and a bit position corresponding to a field of the task descriptor and can update one or more bits of the storage word corresponding to the field, as illustrated in FIG. 5.

Blob 172 can comprise a binary artifact generated by compiler 190. Blob 172 can be generated after compile-time engine 170 has populated one or more task descriptors using generated source code 160. In some examples, blob 172 may comprise accelerator-consumable data that represents at least a portion of model definition 180 in a form usable by NN hardware accelerator 188. Blob 172 may comprise one or more of task descriptors, scheduling information, task ordering information, memory allocation information, buffer identifiers, tensor metadata, operation parameters, kernel identifiers, control values, data movement parameters, or synchronization information. In some examples, blob 172 may comprise a sequence, list, table, graph, stream, or collection of populated task descriptors corresponding to scheduled tasks determined by compile-time engine 170.

Each task descriptor in blob 172 may have one or more fields populated according to layout information encoded by generated source code 160. For example, a task descriptor may comprise fields that represent one or more of an operation type, input tensor address, output tensor address, tensor dimension, tile size, stride, data format, activation mode, post-processing mode, source address, destination address, copy size, synchronization flag, or hardware engine control value. In some examples, compute task descriptors of blob 172 can be usable by compute engines 102 of NN hardware accelerator 188 to perform compute tasks, and copy task descriptors of blob 172 can be usable by copy engines 104 of NN hardware accelerator 188 to perform copy tasks, as illustrated in FIG. 1.

Blob 172 can be provided to NN hardware accelerator 188 to cause NN hardware accelerator 188 to perform at least a portion of neural network execution. In some examples, NN hardware accelerator 188, firmware associated with NN hardware accelerator 188, a driver, a runtime, or a scheduler can read blob 172 and provide task descriptors or information derived from task descriptors to hardware engines of NN hardware accelerator 188. Hardware engines of NN hardware accelerator 188 may use the populated fields of the task descriptors to determine how to perform scheduled tasks, including one or more of selecting an operation, accessing memory, moving data, configuring computation, applying post-processing, or coordinating execution order.

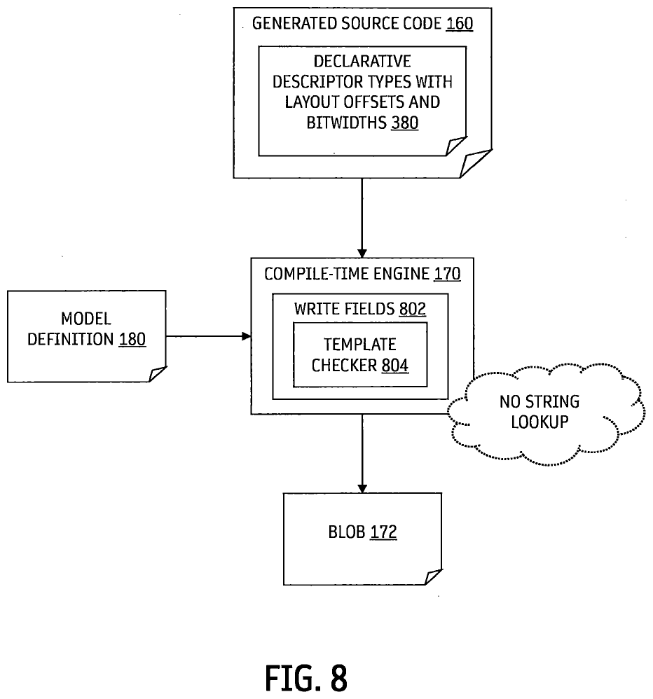

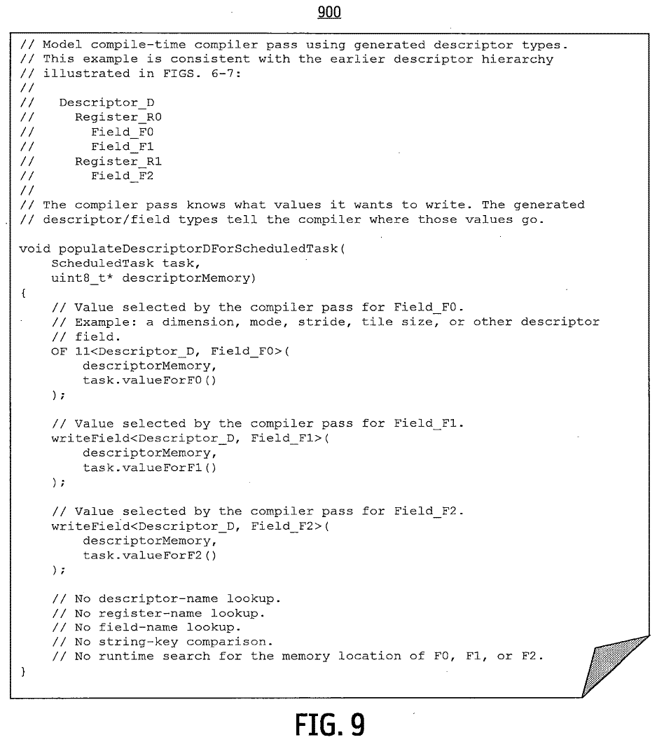

Because blob 172 can comprise task descriptors populated using generated source code 160, blob 172 can reflect descriptor layouts associated with descriptor definitions 150 and, in some examples, a particular accelerator configuration. For instance, descriptor definitions 150 may identify descriptor layouts for compute task descriptors and copy task descriptors, and generated source code 160 may encode layout information for those descriptor layouts. Compile-time engine 170 can use generated source code 160 to populate task descriptors in blob 172 according to the encoded layout information, as illustrated in FIG. 8 and FIG. 9. This can allow blob 172 to have field values positioned according to layouts expected by hardware engines of NN hardware accelerator 188.

NN hardware accelerator 188 is shown as comprising one or more compute engines 102 and one or more copy engines 104 as an illustrative accelerator architecture. Other accelerator architectures may have different numbers, arrangements, or types of hardware engines and may still use task descriptors populated according to generated computer-usable code. Compute engines 102 can perform one or more compute tasks associated with neural network execution, such as one or more of matrix multiplication, convolution, activation, normalization, pooling, element-wise computation, or post-processing. Copy engines 104 can perform one or more copy tasks, data movement tasks, memory transfer tasks, tensor loading tasks, tensor storing tasks, or any combination thereof associated with neural network execution. In some examples, blob 172 may comprise one or more compute task descriptors usable by compute engines 102 and one or more copy task descriptors usable by copy engines 104. In other examples, blob 172 may comprise task descriptors usable by hardware engines having different functions, names, or descriptor formats, and generated source code 160 can encode layout information for the task descriptors associated with those hardware engines.

By generating generated source code 160 based on descriptor definitions 150 before task descriptors are populated by compile-time engine 170, compiler 190 can use encoded layout information during descriptor population. In some examples, compile-time engine 170 can populate a task descriptor without performing, during the populating, a lookup operation to determine where one or more values are to be written in the task descriptor. This can reduce repeated field location lookup operations during generation of blob 172, particularly when model definition 180 results in many scheduled tasks and many task descriptor fields.

### Conventional Descriptor Population Using Lookup Operations

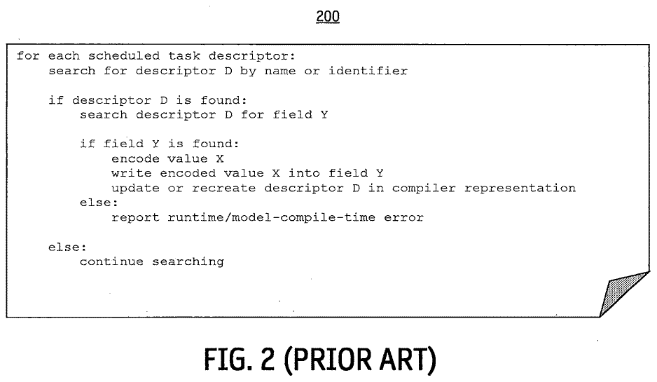

FIG. 2 depicts pseudocode 200 illustrating a conventional process for generating task descriptors. In pseudocode 200, a conventional compiler process iterates through scheduled task descriptors and searches for descriptor D by name or identifier. If descriptor D is found, pseudocode 200 searches descriptor D for field Y. If field Y is found, pseudocode 200 encodes value X, writes encoded value X into field Y, and updates or recreates descriptor D in a compiler representation. If field Y is not found, pseudocode 200 reports a runtime or model compile time error. If descriptor D is not found, pseudocode 200 continues searching.

Pseudocode 200 illustrates that a conventional descriptor population process can perform a lookup operation to determine where a value is to be written in a task descriptor. For example, locating descriptor D by name or identifier and locating field Y within descriptor D may involve one or more of a descriptor-name lookup, field-name lookup, string comparison, map lookup, tree lookup, table lookup, hash lookup, or traversal of a generic descriptor representation. Such lookup operations can be highly undesirable during model compilation because they may be repeated for many scheduled task descriptors and many descriptor fields, causing the compiler to spend processor cycles and memory accesses on locating write positions rather than populating descriptor values for neural network execution.

### Build-Time Generation of Computer-usable Code Encoding Descriptor Layout Information

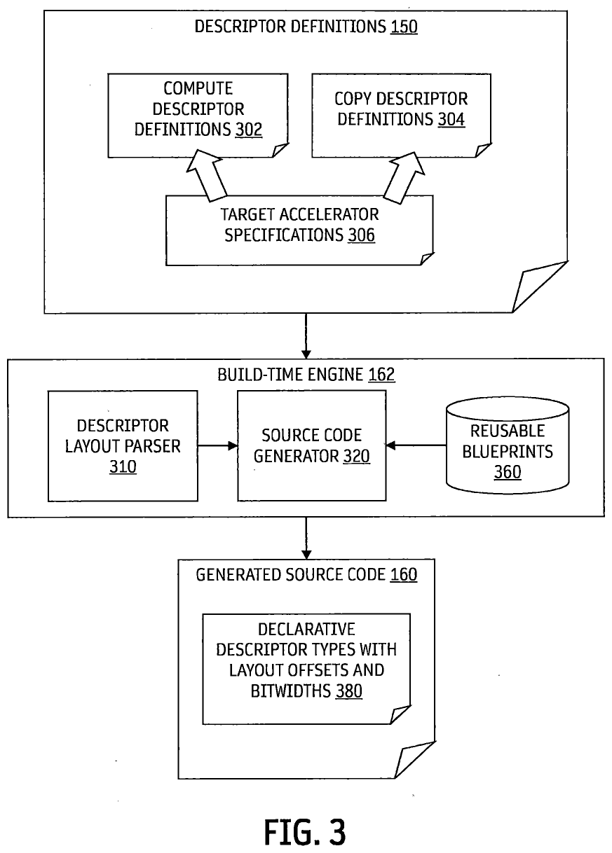

FIG. 3 illustrates build-time engine 162, according to some examples of the disclosure. Build-time engine 162 can generate generated source code 160 based on descriptor definitions 150. Descriptor definitions 150 can comprise one or more of compute descriptor definitions 302, copy descriptor definitions 304, and target accelerator specifications 306. In some examples, descriptor definitions 150 can be an example of descriptor definitions 150 provided to compiler 190, as illustrated in FIG. 1. Descriptor definitions 150 may comprise declarative, semantic, or machine-readable descriptions of task descriptor structures usable by hardware engines of NN hardware accelerator 188, as illustrated in FIG. 1.

Compute descriptor definitions 302 can describe one or more task descriptor structures usable by compute engines 102 of NN hardware accelerator 188, as illustrated in FIG. 1. For example, compute descriptor definitions 302 may describe descriptors for one or more of matrix multiplication, convolution, activation, normalization, pooling, element-wise computation, post-processing, or programmable-kernel execution. In some examples, compute descriptor definitions 302 may identify one or more compute descriptor kinds, compute registers, compute fields, field names, field sizes, field ordering, field relationships, or hardware engine associations. Compute descriptor definitions 302 can be used by build-time engine 162 to generate computer-usable code that later enables compile-time engine 170, as illustrated in FIG. 1, to populate compute task descriptors for scheduled compute tasks.

Copy descriptor definitions 304 can describe one or more task descriptor structures usable by copy engines 104 of NN hardware accelerator 188, as illustrated in FIG. 1. For example, copy descriptor definitions 304 may describe descriptors for one or more of data movement, tensor loading, tensor storing, memory transfer, direct memory access, address generation, buffer copy, format conversion, or synchronization. In some examples, copy descriptor definitions 304 may identify one or more copy descriptor kinds, copy registers, copy fields, field names, field sizes, field ordering, field relationships, source address fields, destination address fields, transfer-size fields, or hardware engine associations. Copy descriptor definitions 304 can be processed separately from, together with, or in coordination with compute descriptor definitions 302.

Target accelerator specifications 306 can identify one or more accelerator configurations for which generated source code 160 is to be generated. In some examples, target accelerator specifications 306 may identify one or more of a hardware generation, hardware revision, product configuration, number of compute engines 102, number of copy engines 104, supported descriptor format, supported operation type, register organization, field layout convention, memory alignment rule, endian rule, or descriptor-size constraint. Target accelerator specifications 306 can be used to select or specialize compute descriptor definitions 302 and copy descriptor definitions 304 before generated source code 160 is generated. For example, descriptor definitions 150 may include descriptor information for multiple accelerator configurations, and target accelerator specifications 306 may identify a particular accelerator configuration whose descriptor layout is to be encoded in generated source code 160.

Build-time engine 162 can comprise one or more of descriptor layout parser 310, source code generator 320, and reusable blueprints 360.

Descriptor layout parser 310 can parse descriptor definitions 150 to extract descriptor structure information used for source code generation. In some examples, descriptor layout parser 310 may parse one or more of compute descriptor definitions 302, copy descriptor definitions 304, or target accelerator specifications 306 to identify descriptor kinds, register groupings, field groupings, field sizes, field ordering, field identifiers, register identifiers, descriptor identifiers, field-to-register relationships, or descriptor-to-engine relationships. Descriptor layout parser 310 can provide parsed descriptor layout information to source code generator 320.

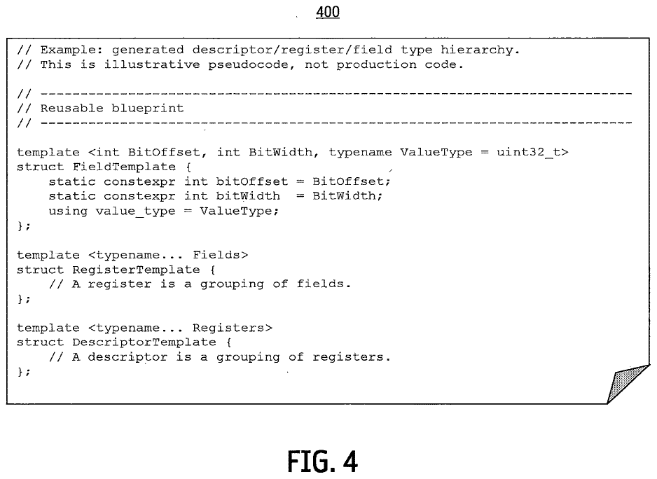

Reusable blueprints 360 can comprise reusable code patterns, templates, type definitions, generation rules, macros, skeleton code, code-emission rules, or any combination thereof used by source code generator 320 to generate generated source code 160. In some examples, reusable blueprints 360 may define how a parsed descriptor, register, or field is represented in generated source code 160. For example, reusable blueprints 360 may define a descriptor type blueprint, register type blueprint, field type blueprint, offset constant blueprint, bit width constant blueprint, or access-function blueprint. Reusable blueprints 360 are further illustrated in FIG. 4. In some examples, use of reusable blueprints 360 can allow source code generator 320 to generate consistent code representations for different descriptor definitions without manually writing descriptor-specific population code for each descriptor layout.

Source code generator 320 can generate generated source code 160 using parsed descriptor layout information from descriptor layout parser 310 and reusable blueprints 360. In some examples, source code generator 320 may emit one or more of generated declarations, generated constants, generated data types, generated templates, generated structures, generated metadata, generated access functions, or generated layout descriptors. Generated source code 160 can be an example of generated computer-usable code that encodes layout information of one or more fields of one or more task descriptors. Although FIG. 3 refers to generated source code 160, generated computer-usable code may additionally or alternatively comprise one or more of source code, header code, intermediate code, object code, compiled binary code, executable code, library code, machine code, bytecode, metadata compiled into a binary, or any combination thereof.

Generated source code 160 can comprise declarative descriptor types with layout offsets and bitwidths 380. Declarative descriptor types with layout offsets and bitwidths 380 can comprise generated data types or code representations corresponding to one or more of a descriptor type, a register type, or a field type. In some examples, a generated field type may encode layout information for a corresponding field, such as one or more of a bit offset, a byte offset, a field width, a field type, a register identifier, a descriptor identifier, a storage word identifier, or a bit position. In some examples, a generated register type may identify a group of field types, and a generated descriptor type may identify one or more register types or field types. An example declarative descriptor type is illustrated in FIG. 6, and generated computer-usable code having layout information for the declarative descriptor type is illustrated in FIG. 7.

Generated source code 160 can be used by compile-time engine 170 to populate task descriptors for scheduled tasks, as illustrated in FIG. 1. In some examples, generated source code 160 allows compile-time engine 170 to write one or more values into one or more fields of a task descriptor according to encoded layout information, rather than performing a lookup operation during descriptor population to determine where the one or more values are to be written. For example, generated source code 160 can allow compile-time engine 170 to determine a storage word and a bit position corresponding to a field and to update one or more bits of the storage word corresponding to the field. This can allow task descriptors in blob 172, as illustrated in FIG. 1, to be generated in accordance with descriptor layouts expected by NN hardware accelerator 188, as illustrated in FIG. 1.

### Reusable Blueprint for Descriptor, Register, and Field Representations

FIG. 4 depicts reusable blueprint 400, according to some examples of the disclosure. Reusable blueprint 400 can provide a reusable pattern for representing a descriptor, register, and field type hierarchy in generated computer-usable code. In some examples, reusable blueprint 400 can be used by source code generator 320, as illustrated in FIG. 3, to generate generated source code 160, as illustrated in FIG. 3. Reusable blueprint 400 is shown using template-style pseudocode to illustrate one possible implementation. In other examples, reusable blueprint 400 may be implemented using one or more of source code templates, generated declarations, macros, code-emission rules, type-generation rules, metadata schemas, intermediate representation templates, object code generation rules, library code, or binary-generation rules.

Reusable blueprint 400 can support generation of declarative descriptor types rather than requiring descriptor-specific write logic to be manually authored for each task descriptor layout. In some examples, reusable blueprint 400 can define a general structure that source code generator 320, as illustrated in FIG. 3, can specialize using descriptor definitions 150, as illustrated in FIG. 3. For example, descriptor definitions 150 may identify fields, registers, descriptor kinds, field sizes, field ordering, field relationships, hardware engine associations, or target accelerator specifications 306, as illustrated in FIG. 3, and source code generator 320 can apply reusable blueprint 400 to produce generated source code 160 that encodes corresponding layout information.

Reusable blueprint 400 includes field template pseudocode represented by FieldTemplate. Field template pseudocode can provide a reusable pattern for representing a field of a task descriptor. In FIG. 4, FieldTemplate is parameterized by BitOffset, BitWidth, and ValueType. BitOffset can represent a location of a field within a task descriptor, register, storage word, descriptor portion, or descriptor memory region. BitWidth can represent a number of bits allocated to the field. ValueType can represent a type of value that may be written into the field, such as one or more of an unsigned integer type, signed integer type, Boolean type, enumeration type, address type, mode type, dimension type, stride type, size type, or control-value type.

Field template pseudocode of reusable blueprint 400 defines bitOffset, bitWidth, and value_type as code-level representations of the field layout and value information. bitOffset can encode the field location represented by BitOffset. bitWidth can encode the field width represented by BitWidth. value_type can encode the value type represented by ValueType. In some examples, source code generator 320, as illustrated in FIG. 3, can generate a field type by substituting field-specific layout information from descriptor definitions 150, as illustrated in FIG. 3, into FieldTemplate. The resulting generated field type can encode layout information for a corresponding field, such as one or more of a bit offset, a byte offset, a field width, a field type, a storage word identifier, a bit position, or a register identifier.

Reusable blueprint 400 includes register template pseudocode represented by RegisterTemplate. Register template pseudocode can provide a reusable pattern for representing a register, logical register, storage word, descriptor section, descriptor portion, or field group. In FIG. 4, RegisterTemplate is parameterized by Fields, which can represent one or more field types associated with a register. Fields may be represented as one or more of a list, collection, sequence, tuple, type pack, metadata set, or generated code construct identifying fields of a register. RegisterTemplate can represent a grouping of fields, such that a generated register type can identify fields that share a register-level organization in a task descriptor.

Register template pseudocode can support descriptor definitions 150 that define a hierarchy in which a given task descriptor has one or more registers and a register has a plurality of fields. For example, compute descriptor definitions 302, as illustrated in FIG. 3, may define compute registers having fields for one or more of operation modes, tensor dimensions, tiling parameters, memory addresses, activation modes, or post-processing controls. Copy descriptor definitions 304, as illustrated in FIG. 3, may define copy registers having fields for one or more of source addresses, destination addresses, transfer sizes, strides, data formats, or synchronization controls. Source code generator 320, as illustrated in FIG. 3, can use register template pseudocode to generate register types for different descriptor layouts while preserving a consistent generated representation of register-field relationships.

Reusable blueprint 400 includes descriptor template pseudocode represented by DescriptorTemplate. Descriptor template pseudocode can provide a reusable pattern for representing a task descriptor. In FIG. 4, DescriptorTemplate is parameterized by Registers, which can represent one or more register types associated with a task descriptor. Registers may be represented as one or more of a list, collection, sequence, tuple, type pack, metadata set, or generated code construct identifying registers of a descriptor. DescriptorTemplate can represent a grouping of registers, such that a generated descriptor type can identify registers associated with a task descriptor.

Descriptor template pseudocode can support generated data types corresponding to one or more of a descriptor type, a register type, or a field type. In some examples, source code generator 320, as illustrated in FIG. 3, can generate a descriptor type by substituting descriptor-specific register information from descriptor definitions 150, as illustrated in FIG. 3, into DescriptorTemplate. A generated descriptor type can represent a compute task descriptor usable by compute engine 102, as illustrated in FIG. 1, or a copy task descriptor usable by copy engine 104, as illustrated in FIG. 1. The same reusable blueprint 400 can be applied to different descriptor layouts associated with different hardware engines or accelerator configurations.

Reusable blueprint 400 can allow generated source code 160 to encode layout information in generated data types instead of relying on runtime lookup operations to determine where values are to be written in a task descriptor. For example, a generated field type may encode a bit offset and bit width for a field, a generated register type may identify a group of generated field types, and a generated descriptor type may identify a group of generated register types. A write field function, as illustrated in FIG. 5, can use these generated data types to write one or more values into one or more fields of a task descriptor according to encoded layout information.

Reusable blueprint 400 can also provide support for descriptor-field compatibility checking. In some examples, a generated descriptor type produced using descriptor template pseudocode may identify register types associated with the generated descriptor type, and each generated register type may identify field types associated with that generated register type. A write function parameterized by a descriptor type and a field type, as illustrated in FIG. 5, may use this generated type hierarchy to verify that a field type is associated with the descriptor type before writing a value into a task descriptor. Such checking can help detect invalid descriptor-field combinations during generation, compilation, build, validation, or use of compiler software.

Although FIG. 4 uses a field template, register template, and descriptor template hierarchy, other hierarchical or non-hierarchical organizations may be used. In some examples, descriptor layout information may be represented using one or more of fields, registers, words, sections, command blocks, descriptor portions, field groups, sub-descriptors, tables, metadata entries, or generated accessors. In some examples, BitOffset, BitWidth, and Value Type may be replaced or supplemented by one or more of a byte offset, storage word identifier, bit position, mask, shift value, alignment value, endian indicator, value encoding rule, descriptor identifier, or register identifier.

Reusable blueprint 400 can provide technical advantages during both build-time source generation and model compile-time descriptor population. At build-time, reusable blueprint 400 can allow build-time engine 162, as illustrated in FIG. 3, to produce generated source code 160 from descriptor definitions 150 according to a consistent pattern, reducing manually maintained descriptor-specific code. At model compile time, generated source code 160 produced using reusable blueprint 400 can allow compile-time engine 170, as illustrated in FIG. 1, to populate task descriptors for scheduled tasks by writing values according to encoded layout information, without performing a lookup operation during population to determine where the values are to be written.

### Write Function Parameterized by Descriptor and Field Types

FIG. 5 depicts write field function 500, according to some examples of the disclosure. Write field function 500 can be a reusable function for writing a value into a field of a task descriptor using layout information encoded by generated computer-usable code. In some examples, write field function 500 can be included in compiler 190, as illustrated in FIG. 1, and can be used by compile-time engine 170, as illustrated in FIG. 1, when populating a task descriptor for a scheduled task. Write field function 500 can operate with declarative descriptor types, register types, and field types generated using reusable blueprint 400, as illustrated in FIG. 4, and can use layout information in generated source code 160, as illustrated in FIG. 3.

Write field function 500 is shown using template-style pseudocode in which function parameters include ‘DescriptorT’ and ‘FieldT’. ‘DescriptorT’ can represent a descriptor type generated from one or more descriptor definitions 150, as illustrated in FIG. 3. ‘FieldT’ can represent a field type generated from descriptor definitions 150. In some examples, ‘FieldT’ can be one of a plurality of generated field types, such as ‘Field_F0’, ‘Field_F1’, or ‘Field_F2’, as illustrated in FIG. 6 and FIG. 7. Each generated field type can encode layout information known at compiler build-time, such as one or more of a bit offset, a byte offset, a field width, a field type, a register identifier, a storage word identifier, or a bit position.

Write field function 500 receives ‘descriptorMemory’ and ‘value’. ‘descriptorMemory’ can identify a memory location associated with a task descriptor being populated. In some examples, ‘descriptorMemory’ may correspond to one or more of a buffer, memory allocation, descriptor object, byte array, output region of blob 172, or compiler-managed memory region. ‘value’ can represent a value to be written into a field of the task descriptor. In some examples, ‘value’ may represent one or more of an operation type, tensor dimension, tile size, stride, memory address, buffer identifier, data format, activation mode, post-processing mode, copy size, source address, destination address, synchronization flag, or hardware engine control value.

Write field function 500 can include a compile-time check that verifies that ‘FieldT’ is associated with ‘DescriptorT’. In FIG. 5, the compile-time check is represented by ‘static_assert(DescriptorT: template contains<FieldT>( ), . . . )’. The compile-time check can determine whether a generated field type belongs to, or is otherwise associated with, a generated descriptor type before a value is written into descriptor memory. In some examples, a generated descriptor type may identify one or more register types, and each register type may identify one or more field types, as illustrated in FIG. 4. The compile-time check can use this generated type hierarchy to detect an invalid descriptor-field combination during compilation, build, validation, or use of compiler software.

The compile-time check of write field function 500 can provide a technical advantage by reducing the likelihood that compile-time engine 170, as illustrated in FIG. 1, writes a value into a field that does not belong to a selected task descriptor. For example, a field type generated for a copy task descriptor may be rejected when used with a descriptor type generated for a compute task descriptor. Similarly, a field type generated for a descriptor layout associated with one accelerator configuration may be rejected when used with a descriptor type generated for a different accelerator configuration. Detecting these mismatches before a task descriptor is included in blob 172, as illustrated in FIG. 1, can improve reliability of accelerator-consumable binary artifacts.

Write field function 500 can obtain ‘bitOffset’ and ‘bitWidth’ from ‘FieldT’. In FIG. 5, ‘bitOffset’ is assigned from ‘FieldT::bitOffset’, and ‘bitWidth’ is assigned from ‘FieldT::bitWidth’. These assignments illustrate that generated field types can expose layout information encoded by generated computer-usable code. ‘bitOffset’ can identify a location of a target field within descriptor memory, and ‘bitWidth’ can identify a number of bits allocated to the target field. In other examples, write field function 500 may use one or more of a byte offset, storage word identifier, bit position, mask, shift value, alignment value, endian indicator, value encoding rule, descriptor identifier, or register identifier encoded by generated source code 160, as illustrated in FIG. 3.

Write field function 500 can determine a storage word and a bit position corresponding to a field of a task descriptor based on layout information encoded by generated computer-usable code. In FIG. 5, ‘wordBits’ is set to 32, ‘wordIndex’ is determined based on ‘bitOffset/wordBits’, and ‘wordOffset’ is determined based on ‘bitOffset % wordBits’. ‘wordBits’ can represent a size of a storage word used by the illustrated example. ‘wordIndex’ can identify which storage word of descriptor memory includes the target field. ‘wordOffset’ can identify a bit position of the target field within that storage word. Although FIG. 5 illustrates a 32-bit storage word, other examples may use different storage word sizes, byte-addressable offsets, multi-word fields, aligned fields, packed fields, or hardware-specific descriptor memory organizations.

Write field function 500 can interpret ‘descriptorMemory’ as one or more storage words. In FIG. 5, ‘words’ is assigned by casting ‘descriptorMemory’ to a pointer to 32-bit words. This allows write field function 500 to access a storage word corresponding to ‘wordIndex’. In some examples, descriptor memory may be accessed as one or more of bytes, half-words, words, double words, vector elements, packed fields, memory-mapped descriptor regions, compiler-managed buffers, or binary artifact regions. The illustrated cast is one example of accessing a descriptor memory location, and other examples may use generated accessor functions, byte-level writes, aligned memory operations, target-specific stores, or intermediate representation updates.

Write field function 500 can generate ‘fieldMask’ based on ‘bitWidth’ and ‘wordOffset’. ‘fieldMask’ can identify one or more bits of a storage word that correspond to the target field. In FIG. 5, ‘fieldMask’ is formed by shifting a bit sequence corresponding to ‘bit Width’ into position according to ‘wordOffset’. The generated mask can allow write field function 500 to update the target field while preserving one or more adjacent fields in the same storage word. In some examples, fieldmask generation may be based on one or more of a field width, bit position, storage word identifier, value encoding rule, sign rule, alignment rule, or hardware descriptor format encoded by generated source code 160, as illustrated in FIG. 3.

Write field function 500 can read ‘oldWord’, generate ‘encodedValue’, generate ‘newWord’, and write ‘newWord’ back to descriptor memory. ‘oldWord’ can represent the storage word before the field update. ‘encodedValue’ can represent ‘value’ shifted to the bit position corresponding to the target field and masked using ‘fieldMask’. ‘newWord’ can combine preserved bits of ‘oldWord’ with ‘encodedValue’, such that bits outside the target field are retained and bits corresponding to the target field are updated. Writing ‘newWord’ to ‘words[wordIndex]’ can populate the field of the task descriptor in the memory location.

Write field function 500 can support populating a task descriptor without performing, during the populating, a lookup operation to determine where the value is to be written in the task descriptor. Instead of searching for a descriptor or field by name at model compile time, compile-time engine 170, as illustrated in FIG. 1, can invoke write field function 500 using a generated descriptor type and a generated field type. The generated field type can provide layout information, and write field function 500 can use the layout information to perform an offset-based or bit-position-based update to descriptor memory. This can reduce repeated field location lookup overhead during generation of blob 172, as illustrated in FIG. 1.

Although FIG. 5 illustrates write field function 500 using template-style pseudocode, write field function 500 may be implemented in different ways. In some examples, write field function 500 may be implemented using one or more of a template function, macro, generated function, inline function, intrinsic, compiled binary routine, library function, code-generation rule, intermediate representation operation, or metadata-driven accessor. In some examples, the compile-time check may be implemented using one or more of a static assertion, type constraint, concept constraint, generated validation table, build-time validator, compiler diagnostic, or code-generation-time check. In some examples, the bit update may be replaced or supplemented by byte-level writes, word-level writes, multi-word writes, target-specific store operations, endian conversion, sign handling, bounds checking, or alignment handling.

### Declarative Descriptor Hierarchy for Descriptor Type D

FIG. 6 depicts example declarative descriptor type D 602, according to some examples of the disclosure. Declarative descriptor type D 602 can be an example of a generated descriptor type included in generated source code 160, as illustrated in FIG. 3.

Declarative descriptor type D 602 can represent a task descriptor structure in a declarative form that identifies one or more register types and one or more field types associated with a task descriptor. In some examples, declarative descriptor type D 602 may be generated by source code generator 320 using reusable blueprint 400, as illustrated in FIGS. 3 and 4.

Declarative descriptor type D 602 can have register type R0 604 and register type R1 606. Register type R0 604 and register type R1 606 can be examples of generated register types corresponding to registers, logical registers, storage words, descriptor portions, field groups, or descriptor sections of a task descriptor. In some examples, register type R0 604 and register type R1 606 can represent groupings of fields within declarative descriptor type D 602. Although FIG. 6 illustrates two register types, declarative descriptor type D 602 may have any number of register types depending on descriptor definitions 150, target accelerator specifications 306, or both, as illustrated in FIG. 3.

Register type R0 604 can have field FO 610 and field F1 612. Field FO 610 and field F1 612 can be examples of generated field types associated with register type R0 604. Each of field FO 610 and field F1 612 can have layout information that includes an offset and a width. Offset can identify a location of a corresponding field within one or more of register type R0 604, declarative descriptor type D 602, a storage word, a descriptor portion, or a memory location associated with a task descriptor. Width can identify a size of the corresponding field, such as a number of bits or bytes allocated to the corresponding field.

Register type R1 606 can have field F2 614. Field F2 614 can be an example of a generated field type associated with register type R1 606. Field F2 614 can have layout information that includes an offset and a width. In some examples, the offset and width of field F2 614 can differ from the offset and width of field FO 610 or field F1 612. For example, field F2 614 may correspond to a field located in a different register, storage word, descriptor portion, or bit range than field FO 610 or field F1 612.

Fields of declarative descriptor type D 602 can represent portions of a task descriptor into which compile-time engine 170 can write values, as illustrated in FIG. 1. For example, field FO 610, field F1 612, or field F2 614 may correspond to one or more of an operation type, tensor dimension, tile size, stride, memory address, buffer identifier, data format, activation mode, post-processing mode, copy size, source address, destination address, synchronization flag, or hardware engine control value. These examples are illustrative, and different descriptor types may define different fields depending on whether the descriptor is usable by compute engine 102, copy engine 104, or another hardware engine of NN hardware accelerator 188, as illustrated in FIG. 1.

Declarative descriptor type D 602 can encode a descriptor hierarchy in which a task descriptor has one or more registers and a register has a plurality of fields. In some examples, declarative descriptor type D 602 can be generated from descriptor definitions 150 that describe such a hierarchy, as illustrated in FIG. 3. For example, descriptor definitions 150 may identify that descriptor D has register RO and register R1, that register RO has fields FO and F1, and that register R1 has field F2. Source code generator 320 can convert this descriptor structure into generated source code 160, as illustrated in FIG. 3, having declarative descriptor type D 602.

Declarative descriptor type D 602 can support descriptor-field compatibility checking. For example, declarative descriptor type D 602 may identify that field FO 610 and field F1 612 are associated with register type R0 604 and that field F2 614 is associated with register type R1 606. Declarative descriptor type D 602 can also identify that register type RO 604 and register type R1 606 are associated with declarative descriptor type D 602. A write function parameterized by a descriptor type and a field type, such as write field function 500 as illustrated in FIG. 5, can use this hierarchy to verify that a field type is associated with a descriptor type before writing a value into a task descriptor.

Declarative descriptor type D 602 can allow compile-time engine 170, as illustrated in FIG. 1, to populate a task descriptor using generated computer-usable code rather than searching a generic descriptor representation for field locations. For example, when compile-time engine 170 writes a value into field F1 612, the layout information of field F1 612 can identify where the value is to be written, such as an offset and width associated with field F1 612. Compile-time engine 170 can use that layout information to write the value into a memory location associated with a task descriptor according to generated source code 160, as illustrated in FIG. 3.

Although FIG. 6 illustrates declarative descriptor type D 602 having register type RO 604, register type R1 606, field FO 610, field F1 612, and field F2 614, other generated descriptor types may have different organizations. In some examples, generated descriptor types may have one register type, more than two register types, fields that are not grouped by register type, nested descriptor portions, command sections, storage words, or field groups. In some examples, generated field types may have layout information comprising one or more of a bit offset, a byte offset, a field width, a field type, a register identifier, a descriptor identifier, a storage word identifier, a bit position, a mask, or a shift value.

Declarative descriptor type D 602 can provide technical advantages by representing task descriptor layout information in generated computer-usable code before model compilation. During task descriptor population, compile-time engine 170, as illustrated in FIG. 1, can use the offset and width of field FO 610, field F1 612, or field F2 614 to determine where and how a value is to be written in descriptor memory. This can reduce or eliminate lookup operations during descriptor population and can improve reliability by allowing generated type relationships to be checked before populated task descriptors are included in blob 172, as illustrated in FIG. 1.

### Generated Computer-Usable Code for Descriptor Type D

FIG. 7 depicts generated computer-usable code 700 having layout information for the declarative descriptor type D, according to some examples of the disclosure. Generated computer-usable code 700 can be an example of generated source code 160, as illustrated in FIG. 3. In some examples, generated computer-usable code 700 can be generated by source code generator 320, as illustrated in FIG. 3, using descriptor definitions 150 and reusable blueprint 400, as illustrated in FIGS. 3 and 4. Generated computer-usable code 700 is shown using template-style pseudocode to illustrate one possible implementation, but generated computer-usable code 700 may additionally or alternatively comprise one or more of source code, header code, generated declarations, generated data types, intermediate code, object code, compiled binary code, executable code, library code, machine code, bytecode, metadata compiled into a binary, or any combination thereof.

Generated computer-usable code 700 includes generated field type FO 610, generated field type F1 612, and generated field type F2 614. Generated field type F0 610, generated field type F1 612, and generated field type F2 614 can correspond to field FO 610, field F1 612, and field F2 614 of declarative descriptor type D 602, as illustrated in FIG. 6.

Each generated field type can encode layout information of a corresponding field of a task descriptor. For example, generated field type F0 610 can encode a bit offset of 0 and a bit width of 10, generated field type F1 612 can encode a bit offset of 10 and a bit width of 6, and generated field type F2 614 can encode a bit offset of 32 and a bit width of 16.

Generated field type F0 610 is shown as a specialization of FieldTemplate with a bit offset value and a bit width value. In some examples, generated field type F0 610 may be generated by substituting field-specific information from descriptor definitions 150, as illustrated in FIG. 3, into field template pseudocode of reusable blueprint 400, as illustrated in FIG. 4. Generated field type F0 610 can expose layout information in a code-level form usable by write field function 500, as illustrated in FIG. 5. For example, write field function 500 can use the bit offset and bit width encoded by generated field type F0 610 to determine where and how a value is to be written into descriptor memory.

Generated field type F1 612 is also shown as a specialization of FieldTemplate with a bit offset value and a bit width value. In FIG. 7, generated field type F1 612 starts at a different bit offset and has a different bit width than generated field type F0 610. This illustrates that generated computer-usable code 700 can encode field-specific layout information for multiple fields of a task descriptor, even when the fields share a register type, storage word, descriptor portion, or descriptor memory region. In some examples, generated field type F1 612 may represent a field for one or more of an operation mode, tensor dimension, tile size, stride, memory address, buffer identifier, data format, activation mode, post-processing mode, copy size, source address, destination address, synchronization flag, or hardware engine control value.

Generated field type F2 614 is shown as a specialization of FieldTemplate having a bit offset of 32 and a bit width of 16. In some examples, generated field type F2 614 can correspond to a field in a different register type, storage word, or descriptor portion than generated field type F0 610 or generated field type F1 612. The different bit offset and bit width values shown for generated field type F2 614 illustrate that generated computer-usable code 700 can represent nonuniform descriptor layouts in which different fields occupy different locations and sizes within a task descriptor.

Generated computer-usable code 700 includes generated register type RO 604 and generated register type R1 606. Generated register type R0 604 can be generated as a specialization of RegisterTemplate that identifies generated field type F0 610 and generated field type F1 612. Generated register type R1 606 can be generated as a specialization of RegisterTemplate that identifies generated field type F2 614. Generated register type R0 604 and generated register type R1 606 can correspond to register type RO 604 and register type R1 606 of declarative descriptor type D 602, as illustrated in FIG. 6. In some examples, each generated register type can identify one or more field types that are grouped together in a corresponding register, logical register, storage word, descriptor section, descriptor portion, or field group.

Generated computer-usable code 700 includes generated descriptor type D 602. Generated descriptor type D 602 can be generated as a specialization of DescriptorTemplate that identifies generated register type R0 604 and generated register type R1 606. Generated descriptor type D 602 can correspond to declarative descriptor type D 602, as illustrated in FIG. 6. In some examples, generated descriptor type D 602 can represent a compute task descriptor usable by compute engine 102, as illustrated in FIG. 1, or a copy task descriptor usable by copy engine 104, as illustrated in FIG. 1. The particular field offsets, field widths, register groupings, and descriptor groupings shown in FIG. 7 are illustrative, and other generated descriptor types may encode different layouts based on descriptor definitions 150 and target accelerator specifications 306, as illustrated in FIG. 3.

Generated descriptor type D 602 includes a contains function parameterized by FieldT. The contains function can provide descriptor-field association information for generated descriptor type D 602. In FIG. 7, the contains function returns a value indicating whether FieldT corresponds to generated field type F0 610, generated field type F1 612, or generated field type F2 614. In some examples, this descriptor-field association information can be used by write field function 500, as illustrated in FIG. 5, to verify that a field type is associated with a descriptor type before writing a value into a task descriptor. In some examples, the contains function is optional.

The descriptor-field association information encoded by generated descriptor type D 602 can support compile-time descriptor-field compatibility checking. For example, if compile-time engine 170, as illustrated in FIG. 1, invokes write field function 500 using generated descriptor type D 602 and generated field type F1 612, write field function 500 can determine that generated field type F1 612 is associated with generated descriptor type D 602. If compile-time engine 170 invokes write field function 500 using generated descriptor type D 602 and a field type that is not associated with generated descriptor type D 602, write field function 500 may produce a compile-time, build-time, validation-time, or code-generation-time error. This can reduce the likelihood that an invalid descriptor-field combination is used to populate a task descriptor for blob 172, as illustrated in FIG. 1.

Generated computer-usable code 700 can allow compile-time engine 170, as illustrated in FIG. 1, to populate a task descriptor without performing, during the populating, a lookup operation to determine where a value is to be written in the task descriptor. For example, generated field type F1 612 can already encode that a corresponding field starts at bit offset 10 and has a bit width of 6. Compile-time engine 170 can invoke write field function 500, as illustrated in FIG. 5, using generated descriptor type D 602 and generated field type F1 612, and write field function 500 can use the encoded layout information to perform an offset-based or bit-position-based update to descriptor memory. This can avoid one or more of a field-name lookup, descriptor-name lookup, string comparison, map lookup, tree lookup, table lookup, hash lookup, or traversal of a generic descriptor representation during descriptor population.

Generated computer-usable code 700 can also support bit-level memory updates for task descriptor fields. For example, the bit offset and bit width encoded by generated field type F0 610, generated field type F1 612, or generated field type F2 614 can be used to determine a storage word and a bit position corresponding to a target field. Write field function 500, as illustrated in FIG. 5, can update one or more bits of the storage word corresponding to the target field while preserving adjacent bits associated with one or more fields of the same task descriptor. In some examples, generated computer-usable code 700 may also encode one or more of a byte offset, field type, register identifier, descriptor identifier, storage word identifier, bit position, mask, shift value, alignment value, endian indicator, or value encoding rule.

Although generated computer-usable code 700 is shown as explicitly declaring generated field types, generated register types, generated descriptor type D 602, and descriptor-field association logic, other generated representations may be used. In some examples, generated computer-usable code 700 may represent layout information using one or more of constants, structures, class definitions, type aliases, tables, metadata objects, generated accessors, macros, inline functions, serialized metadata, intermediate representation constructs, object code symbols, or compiled binary routines. The generated representation may still encode layout information of one or more fields of one or more task descriptors and may still be usable to populate task descriptors according to that encoded layout information.

Generated computer-usable code 700 can provide a bridge between build-time descriptor information and model compile-time descriptor population. At build-time, source code generator 320, as illustrated in FIG. 3, can convert descriptor definitions 150 into generated computer-usable code 700. At model compile time, compile-time engine 170, as illustrated in FIG. 1, can use generated computer-usable code 700 to write values into one or more fields of a task descriptor for a scheduled task. This organization can reduce repeated field location discovery during generation of blob 172, as illustrated in FIG. 1, and can help ensure that values are written according to descriptor layouts expected by NN hardware accelerator 188, as illustrated in FIG. 1.

### Compile-Time Population of Task Descriptors Using Generated Layout Information

FIG. 8 illustrates compile-time engine 170, according to some examples of the disclosure. Compile-time engine 170 can represent a model compile-time portion of compiler 190, as illustrated in FIG. 1. Compile-time engine 170 can receive or access model definition 180 and generated source code 160 and can generate blob 172. In some examples, compile-time engine 170 can use generated source code 160 to populate one or more task descriptors for one or more scheduled tasks associated with model definition 180. Blob 172 can comprise the populated task descriptors and can be usable by NN hardware accelerator 188 to perform at least a portion of neural network execution, as illustrated in FIG. 1.

Generated source code 160 can comprise declarative descriptor types with layout offsets and bitwidths 380. Declarative descriptor types with layout offsets and bitwidths 380 can be generated by build-time engine 162, as illustrated in FIG. 3. In some examples, generated source code 160 can comprise generated computer-usable code that encodes layout information of one or more fields of one or more task descriptors. For example, generated source code 160 may comprise one or more generated data types corresponding to one or more of a descriptor type, a register type, or a field type, as illustrated in FIGS. 6 and 7. Generated source code 160 may encode layout information comprising one or more of a bit offset, a byte offset, a field width, a field type, a register identifier, a descriptor identifier, a storage word identifier, a bit position, a mask, or a shift value.

Model definition 180 can be provided to compile-time engine 170. Model definition 180 can describe a neural network model to be compiled for execution by NN hardware accelerator 188, as illustrated in FIG. 1. In some examples, compile-time engine 170 can process model definition 180 to determine one or more scheduled tasks. Such scheduled tasks may comprise one or more of compute tasks, copy tasks, data movement tasks, tensor loading tasks, tensor storing tasks, memory transfer tasks, matrix multiplication tasks, convolution tasks, activation tasks, normalization tasks, pooling tasks, element-wise computation tasks, or post-processing tasks. Compile-time engine 170 can determine one or more values to be written into task descriptors for the scheduled tasks.

Compile-time engine 170 can comprise write fields 802. Write fields 802 can represent one or more operations, functions, modules, routines, passes, or code portions that populate task descriptors using generated source code 160. In some examples, write fields 802 can write, to a memory location associated with a task descriptor, one or more values into one or more fields of the task descriptor according to layout information encoded by generated source code 160. For example, write fields 802 may write values representing one or more of an operation type, tensor dimension, tile size, stride, memory address, buffer identifier, data format, activation mode, post-processing mode, copy size, source address, destination address, synchronization flag, or hardware engine control value.

Write fields 802 can invoke or implement write field function 500, as illustrated in FIG. 5. In some examples, write fields 802 can invoke a write function parameterized by a descriptor type and a field type. The descriptor type and field type can be generated data types included in generated source code 160. For example, write fields 802 may invoke write field function 500 using declarative descriptor type D 602 and field FO 610, field F1 612, or field F2 614, as illustrated in FIGS. 6 and 7. The generated field type can provide layout information used by write field function 500 to determine where and how a value is to be written into descriptor memory.

In some examples, compile-time engine 170 can comprise template checker 804. Template checker 804 can perform a compile-time, build-time, validation-time, code-generation-time, or type-checking operation that verifies whether a field type is associated with a descriptor type. In some examples, template checker 804 can correspond to, implement, or use a compile-time check of write field function 500, as illustrated in FIG. 5. For example, generated descriptor type D 602 may include descriptor-field association information, such as a contains function that identifies whether a field type is associated with generated descriptor type D 602, as illustrated in FIG. 7. Template checker 804 can use such descriptor-field association information to validate descriptor-field combinations before or during task descriptor population.

Template checker 804 can improve reliability of task descriptor generation by reducing use of invalid descriptor-field combinations. For example, template checker 804 may prevent write fields 802 from using a field type associated with a copy task descriptor when populating a compute task descriptor, or from using a field type associated with one accelerator configuration when populating a descriptor type associated with a different accelerator configuration. In some examples, template checker 804 can cause a compiler diagnostic, build-time error, validation error, or code-generation error when a field type is not associated with a descriptor type. This can reduce the likelihood that blob 172 includes a task descriptor having a field value written according to an incorrect descriptor layout.

Write fields 802 can populate task descriptors without performing a string lookup to determine where one or more values are to be written. Compile-time engine 170 can avoid string-based field location discovery during task descriptor population. In some examples, write fields 802 may avoid one or more of a descriptor-name lookup, field-name lookup, string comparison, map lookup, tree lookup, table lookup, hash lookup, or traversal of a generic descriptor representation during population of a task descriptor. Instead, write fields 802 can use layout information encoded by generated source code 160 to perform offset-based, type-based, storage-word-based, or bit-position-based writes.

Avoiding string lookup can provide a technical advantage during model compilation because compile-time engine 170 may populate many task descriptors and many task descriptor fields for model definition 180. Repeated lookup operations can require processor cycles, memory accesses, branching, and generic descriptor object manipulation that do not directly write descriptor values. By using generated source code 160 having declarative descriptor types with layout offsets and bitwidths 380, compile-time engine 170 can convert field population into direct or specialized memory update operations. This can reduce descriptor population overhead and can reduce model compilation time, particularly for neural network models that generate many scheduled tasks.

Blob 172 can be generated by compile-time engine 170 after one or more task descriptors are populated by write fields 802. In some examples, blob 172 can comprise one or more compute task descriptors usable by compute engines 102 and one or more copy task descriptors usable by copy engines 104, as illustrated in FIG. 1. Blob 172 can comprise task descriptors having fields populated according to descriptor layouts encoded in generated source code 160. As a result, blob 172 can be usable by NN hardware accelerator 188, as illustrated in FIG. 1, to perform one or more tasks associated with neural network execution.

Although FIG. 8 shows generated source code 160 being provided to compile-time engine 170, generated computer-usable code may be provided to or used by compile-time engine 170 in different forms. In some examples, generated computer-usable code may comprise one or more of source code, header code, generated declarations, generated data types, intermediate code, object code, compiled binary code, executable code, library code, machine code, bytecode, metadata compiled into a binary, or any combination thereof. In some examples, compile-time engine 170 may be implemented as one or more compiler passes, lowering passes, code-generation passes, scheduling passes, descriptor population passes, runtime tools, firmware tools, driver tools, or build system components that use generated computer-usable code to populate task descriptors.

### Generating a Binary Artifact Comprising Populated Task Descriptors

FIG. 9 depicts pseudocode 900 illustrating populating a task descriptor, according to some examples of the disclosure. Pseudocode 900 can represent a model compile-time compiler pass that uses generated descriptor types to populate a task descriptor for a scheduled task. In some examples, pseudocode 900 can be performed by compile-time engine 170, as illustrated in FIG. 8. Pseudocode 900 is shown using function-style pseudocode for clarity, but the illustrated operations may be implemented using one or more of a compiler pass, lowering pass, code-generation pass, descriptor population pass, runtime tool, firmware tool, driver tool, generated function, inline function, macro, library routine, or intermediate representation operation.

Pseudocode 900 is consistent with the descriptor hierarchy of declarative descriptor type D 602, as illustrated in FIG. 6, and generated computer-usable code 700, as illustrated in FIG. 7. In the illustrated hierarchy, descriptor D has register RO and register R1. Register RO has field FO and field F1, and register R1 has field F2. In some examples, descriptor D can correspond to declarative descriptor type D 602, register RO can correspond to register type R0 604, register R1 can correspond to register type R1 606, field F0 can correspond to field F0 610, field F1 can correspond to field F1 612, and field F2 can correspond to field F2 614, as illustrated in FIG. 6. This hierarchy may be generated using reusable blueprint 400, as illustrated in FIG. 4.

Pseudocode 900 includes function populateDescriptorDForScheduledTask, which can populate a task descriptor corresponding to descriptor D for a scheduled task. The function receives ScheduledTask task and descriptorMemory. ScheduledTask task can represent a scheduled task determined by compile-time engine 170 based on model definition 180, as illustrated in FIG. 8. For example, scheduled task may represent one or more of a compute task, copy task, data movement task, tensor loading task, tensor storing task, memory transfer task, matrix multiplication task, convolution task, activation task, normalization task, pooling task, element-wise computation task, or post-processing task. descriptorMemory can represent a memory location associated with a task descriptor being populated for the scheduled task.

Pseudocode 900 illustrates that the compiler pass can know or determine values to be written into fields of a task descriptor before invoking write operations. In some examples, task. valueForF0( ), task. valueForF1( ), and task. valueForF2( ) can represent values determined from one or more of model definition 180, scheduling decisions, tensor shapes, tiling decisions, memory allocation decisions, data movement decisions, hardware engine selection, target accelerator specifications 306, or compiler metadata, as illustrated in FIGS. 3 and 8. Such values may represent one or more of an operation type, tensor dimension, tile size, stride, memory address, buffer identifier, data format, activation mode, post-processing mode, copy size, source address, destination address, synchronization flag, or hardware engine control value.

Pseudocode 900 invokes write field function 500 to write values into field FO, field F1, and field F2 of descriptor D. A first invocation writeField<Descriptor_D, Field_F0>can write a value from task. valueForF0( ) into field F0. A second invocation writeField<Descriptor_D, Field_F1>can write a value from task. valueForF1( ) into field F1. A third invocation writeField<Descriptor_D, Field_F2>can write a value from task. valueForF2( ) into field F2. In some examples, each invocation can pass descriptorMemory to identify the memory location to be updated. Write field function 500 is illustrated in FIG. 5.

Each write field invocation in pseudocode 900 can be parameterized by a descriptor type and a field type. For example, Descriptor_D can be a generated descriptor type corresponding to descriptor D, and Field_F0, Field_F1, and Field_F2 can be generated field types corresponding to fields of descriptor D, as illustrated in FIG. 7. The generated field types can encode layout information, such as one or more of a bit offset, a byte offset, a field width, a field type, a register identifier, a descriptor identifier, a storage word identifier, or a bit position. Write field function 500 can use the encoded layout information to write a corresponding value into the proper portion of descriptorMemory, as illustrated in FIG. 5.

In some examples, each write field invocation can cause write field function 500 to verify that the field type is associated with the descriptor type before writing a value into descriptorMemory. For example, write field function 500 may use descriptor-field association information of generated descriptor type D 602, such as the contains function illustrated in generated computer-usable code 700 of FIG. 7. This can allow a compiler diagnostic, build-time error, validation error, or code-generation error to occur if an invalid field type is used with Descriptor_D. As a result, pseudocode 900 can support descriptor-field compatibility checking while populating task descriptors.

Pseudocode 900 illustrates populating a task descriptor without performing, during the populating, a lookup operation to determine where values are to be written in the task descriptor. In some examples, the compiler pass can avoid one or more of a descriptor-name lookup, register-name lookup, field-name lookup, string-key comparison, map lookup, tree lookup, table lookup, hash lookup, or runtime search for a memory location of field FO, field F1, or field F2. Instead, the compiler pass can invoke write field function 500 with generated descriptor and field types, and the generated field types can provide the layout information used to determine the appropriate write location.

Avoiding lookup operations during descriptor population can reduce overhead in the model compile-time path. For example, if compile-time engine 170 populates many task descriptors for many scheduled tasks, repeated field location lookup operations can consume processor cycles and memory accesses that do not directly populate descriptor values. Pseudocode 900 can reduce this overhead because field location information is already encoded in generated computer-usable code 700, as illustrated in FIG. 7. The compiler pass can use that encoded information to perform type-based, offset-based, storage-word-based, or bit-position-based writes into descriptorMemory.

After pseudocode 900 populates descriptor D in descriptorMemory, the populated task descriptor can be included in blob 172, as illustrated in FIG. 8. Blob 172 can then be usable by NN hardware accelerator 188, as illustrated in FIG. 1, to perform at least a portion of neural network execution. In some examples, pseudocode 900 may be repeated for additional scheduled tasks, additional descriptor types, additional fields, compute task descriptors usable by compute engines 102, copy task descriptors usable by copy engines 104, or descriptor layouts associated with a particular accelerator configuration, as illustrated in FIGS. 1 and 3.

### Example Methods for Efficient Generation of Task Descriptors Usable by an Accelerator

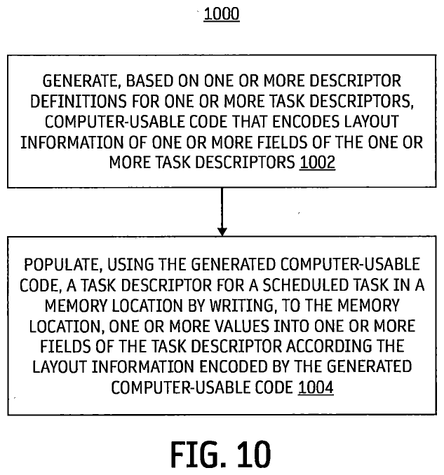

FIG. 10 is a flow diagram illustrating method 1000 for efficient generation of task descriptors usable by an accelerator, according to some examples of the disclosure. Method 1000 can be performed by one or more processors executing instructions stored by one or more non-transitory computer-readable media. In some examples, method 1000 can be performed by computing system 100, compiler 190, build-time engine 162, compile-time engine 170, or any combination thereof, as illustrated in FIGS. 1, 3, and 8. Method 1000 can be used to generate computer-usable code that encodes layout information of task descriptor fields and to populate task descriptors using the generated computer-usable code.

In 1002, computing system 100 can generate, based on one or more descriptor definitions for one or more task descriptors, computer-usable code that encodes layout information of one or more fields of the one or more task descriptors. In some examples, the one or more descriptor definitions can correspond to descriptor definitions 150, as illustrated in FIGS. 1 and 3. The one or more task descriptors can be usable by one or more hardware engines of an accelerator to perform one or more tasks associated with neural network execution. For example, the one or more task descriptors may comprise one or more compute task descriptors usable by compute engines 102, one or more copy task descriptors usable by copy engines 104, or both, as illustrated in FIG. 1.

Performing 1002 can include processing descriptor definitions that describe descriptor structures at a declarative, semantic, or machine-readable level. In some examples, the descriptor definitions may comprise one or more of compute descriptor definitions 302, copy descriptor definitions 304, or target accelerator specifications 306, as illustrated in FIG. 3. The descriptor definitions may identify one or more descriptor kinds, registers, fields, field names, field relationships, field sizes, field ordering, hardware engine associations, accelerator configurations, or descriptor layouts. In some examples, the descriptor definitions may identify a descriptor layout associated with a particular accelerator configuration, and the generated computer-usable code can encode the descriptor layout associated with the particular accelerator configuration.

Performing 1002 can include parsing the descriptor definitions and applying reusable blueprints to generate code-level representations of descriptor structure. For example, descriptor layout parser 310 can parse descriptor definitions 150, and source code generator 320 can use reusable blueprints 360 to generate generated source code 160, as illustrated in FIG. 3. In some examples, reusable blueprint 400 can define reusable patterns for field, register, and descriptor representations, as illustrated in FIG. 4. The generated computer-usable code may comprise one or more of source code, header code, generated declarations, generated data types, intermediate code, object code, compiled binary code, executable code, library code, machine code, bytecode, metadata compiled into a binary, or any combination thereof.

The layout information generated in 1002 can comprise, for a field of the one or more fields, one or more of a bit offset, a byte offset, a field width, a field type, a register identifier, a descriptor identifier, a storage word identifier, a bit position, a mask, or a shift value. In some examples, the generated computer-usable code can comprise one or more generated data types corresponding to one or more of a descriptor type, a register type, or a field type of the one or more task descriptors. For example, generated computer-usable code 700 can include generated field types, generated register types, and generated descriptor type D 602, as illustrated in FIG. 7. Generated descriptor type D 602 can correspond to declarative descriptor type D 602 having register type R0 604, register type R1 606, field F0 610, field F1 612, and field F2 614, as illustrated in FIG. 6.

In 1004, computing system 100 can populate, using the generated computer-usable code, a task descriptor for a scheduled task in a memory location by writing, to the memory location, one or more values into one or more fields of the task descriptor according to the layout information encoded by the generated computer-usable code. In some examples, 1004 can be performed by compile-time engine 170, as illustrated in FIG. 8. The scheduled task may be determined based on model definition 180, as illustrated in FIGS. 1 and 8. For example, the scheduled task may comprise one or more of a compute task, copy task, data movement task, tensor loading task, tensor storing task, memory transfer task, matrix multiplication task, convolution task, activation task, normalization task, pooling task, element-wise computation task, or post-processing task.

Performing 1004 can include determining one or more values to be written into the task descriptor for the scheduled task. In some examples, the one or more values may be determined from one or more of model definition 180, scheduling decisions, tensor shapes, tiling decisions, memory allocation decisions, data movement decisions, hardware engine selection, target accelerator specifications 306, or compiler metadata, as illustrated in FIGS. 3 and 8. The one or more values may represent one or more of an operation type, tensor dimension, tile size, stride, memory address, buffer identifier, data format, activation mode, post-processing mode, copy size, source address, destination address, synchronization flag, or hardware engine control value.

Performing 1004 can include invoking a write function parameterized by a descriptor type and a field type. For example, compile-time engine 170 may invoke write field function 500 using a generated descriptor type and a generated field type, as illustrated in FIGS. 5, 8, and 9. In some examples, the generated field type can encode layout information, and write field function 500 can use the encoded layout information to determine where and how a value is to be written into descriptor memory. Performing 1004 may include determining, based on the layout information encoded by the generated computer-usable code, a storage word and a bit position corresponding to a field of the task descriptor, and updating one or more bits of the storage word corresponding to the field.

Performing 1004 can include checking descriptor-field compatibility before or during field population. In some examples, write field function 500 can include a compile-time check that verifies that a field type is associated with a descriptor type, as illustrated in FIG. 5. For example, generated descriptor type D 602 can include descriptor-field association information identifying generated field type F0 610, generated field type F1 612, and generated field type F2 614 as associated with generated descriptor type D 602, as illustrated in FIG. 7. Template checker 804 can use such descriptor-field association information to validate descriptor-field combinations, as illustrated in FIG. 8. This can reduce invalid descriptor-field writes before task descriptors are included in blob 172.

Performing 1004 can include writing the one or more values into the one or more fields without performing, during the populating, a lookup operation to determine where the one or more values are to be written in the task descriptor. In some examples, compile-time engine 170 may avoid one or more of a descriptor-name lookup, register-name lookup, field-name lookup, string-key comparison, map lookup, tree lookup, table lookup, hash lookup, or runtime search for a memory location of a field, as illustrated in FIGS. 8 and 9. Instead, compile-time engine 170 can use layout information already encoded by the generated computer-usable code to perform type-based, offset-based, storage-word-based, or bit-position-based writes into the memory location.

Method 1000 may further include generating a binary artifact comprising the task descriptor populated using the generated computer-usable code. In some examples, the binary artifact can correspond to blob 172, as illustrated in FIGS. 1 and 8. Blob 172 may comprise one or more populated task descriptors, scheduling information, task ordering information, memory allocation information, buffer identifiers, tensor metadata, operation parameters, kernel identifiers, control values, data movement parameters, synchronization information, or any combination thereof. Blob 172 can be usable by NN hardware accelerator 188, as illustrated in FIG. 1, to perform at least a portion of neural network execution.

Method 1000 can provide technical advantages by separating descriptor layout generation from model compile-time descriptor population. In some examples, 1002 can move descriptor layout resolution into generated computer-usable code, and 1004 can use that generated computer-usable code to write values into task descriptor fields without repeatedly performing lookup operations during population. This can reduce processor cycles, memory accesses, branching, string comparisons, generic descriptor traversals, and temporary descriptor object manipulation during model compilation. Method 1000 can also improve reliability by enabling descriptor-field compatibility checking and can improve descriptor correctness by using encoded layout information to perform precise bit-level updates in task descriptor memory.

### Exemplary Computing Device

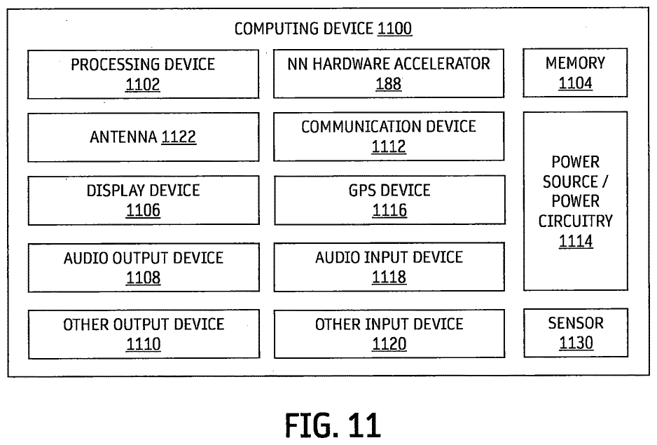

FIG. 11 is a block diagram of an apparatus or a system, e.g., an exemplary computing device 1100, according to some examples of the disclosure. One or more computing devices 1100 may be used to implement the functionalities described with the FIGS. and herein. A number of components are illustrated in the FIGS. that can be included in computing device 1100, but any one or more of these components may be omitted or duplicated, as suitable for the application. In some examples, some or all of the components included in computing device 1100 may be attached to one or more motherboards. In some examples, some or all of these components are fabricated onto a single system-on-chip die. Additionally, in various examples, computing device 1100 may not include one or more of the components illustrated in FIG. 11, and computing device 1100 may include interface circuitry for coupling to the one or more components. For example, computing device 1100 may not include a display device 1106, and may include display device interface circuitry (e.g., a connector and driver circuitry) to which a display device 1106 may be coupled. In another set of examples, computing device 1100 may not include an audio input device 1118 or an audio output device 1108 and may include audio input or output device interface circuitry (e.g., connectors and supporting circuitry) to which an audio input device 1118 or audio output device 1108 may be coupled.

Computing device 1100 may include a processing device 1102 (e.g., one or more processing devices, one or more of the same type of processing device, one or more of different types of processing devices). The processing device 1102 may include electronic circuitry that processes electronic data from data storage elements (e.g., registers, memory, resistors, capacitors, quantum bit cells) to transform that electronic data into other electronic data that may be stored in registers and/or memory. Examples of processing device 1102 may include a CPU, a GPU, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a FPGA, a TPU, a data processing unit (DPU), etc.

In some examples, computing device 1100 may include NN hardware accelerator 188. NN hardware accelerator 188 can interface with processing device 1102 to accelerate inference, training, artificial intelligence, machine learning, graphics, signal processing, image processing, video processing, data processing, networking, security, compression, decompression, or suitable compute operations. In some examples, NN hardware accelerator 188 may be implemented as one or more of a neural network accelerator, artificial intelligence accelerator, machine learning accelerator, graphics processing unit, image signal processor, video processing unit, digital signal processor, data processing unit, infrastructure processing unit, network processing unit, security accelerator, cryptographic accelerator, compression accelerator, decompression accelerator, or suitable multi-tile or multi-agent processing device. NN hardware accelerator 188 may include one or more components described with reference to FIG. 1. For example, NN hardware accelerator 188 may include one or more of: one or more compute engines 102 and one or more copy engines 104.

Computing device 1100 may include a memory 1104, which may itself include one or more memory devices such as volatile memory (e.g., DRAM), nonvolatile memory (e.g., ROM), HBM, flash memory, solid-state memory, and/or a hard drive. Memory 1104 includes one or more non-transitory computer-readable storage media. In some examples, memory 1104 may include memory that shares a die with the processing device 1102.

In some examples, memory 1104 includes one or more non-transitory computer-readable media storing instructions executable to perform operations described with FIGS. 1 and 3-10 and herein. The instructions stored in the one or more non-transitory computer-readable media may be executed by processing device 1102. For example, the instructions may be executable to cause processing device 1102 to perform one or more of generating computer-usable code based on descriptor definitions 150, parsing descriptor definitions 150 using descriptor layout parser 310, generating generated source code 160 using source code generator 320 and reusable blueprints 360, using generated source code 160 to populate one or more task descriptors for one or more scheduled tasks, invoking write field function 500, performing descriptor-field compatibility checking using template checker 804, generating blob 172, or performing method 1000, as described with FIGS. 1 and 3-10.

In some examples, memory 1104 may store data, such as descriptor definitions 150, compute descriptor definitions 302, copy descriptor definitions 304, target accelerator specifications 306, reusable blueprints 360, reusable blueprint 400, generated source code 160, declarative descriptor types with layout offsets and bitwidths 380, generated computer-usable code 700, declarative descriptor type D 602, register type RO 604, register type R1 606, field FO 610, field F1 612, field F2 614, model definition 180, populated task descriptors, scheduled task information, descriptor memory, blob 172, or any combination thereof, as described with FIGS. 1 and 3-10 and herein. Data may include inputs and outputs to NN hardware accelerator 188, such as input tensors, output tensors, input activations, output feature maps, weights of weight matrices, operation parameters, intermediate feature maps, model parameters, layer parameters, source addresses, destination addresses, transfer sizes, memory attributes, and data movement descriptors.

In some examples, computing device 1100 may include a communication device 1112 (e.g., one or more communication devices). For example, communication device 1112 may be configured for managing wired and/or wireless communications for the transfer of data to and from computing device 1100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not include any wires, although in some examples they might not. Communication device 1112 may implement any of a number of wireless standards or protocols. Computing device 1100 may include an antenna 1122 to facilitate wireless communications and/or to receive other wireless communications (such as radio frequency transmissions). Computing device 1100 may include receiver circuits and/or transmitter circuits. In some examples, the communication device 1112 may manage wired communications, such as electrical, optical, or any other suitable communication protocols (e.g., Ethernet). As noted above, the communication device 1112 may include multiple communication chips. For instance, a first communication device 1112 may be dedicated to shorter-range wireless communications, such as Wi-Fi or Bluetooth, and a second communication device 1112 may be dedicated to longer-range wireless communications. In some examples, a first communication device 1112 may be dedicated to wireless communications, and a second communication device 1112 may be dedicated to wired communications.

Computing device 1100 may include power source/power circuitry 1114.

The power source/power circuitry 1114 may include one or more energy storage devices (e.g., batteries or capacitors) and/or circuitry for coupling components of computing device 1100 to an energy source separate from computing device 1100 (e.g., DC power, AC power, etc.).

Computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

Computing device 1100 may include an audio output device 1108 (or corresponding interface circuitry, as discussed above). The audio output device 1108 may include any device that generates an audible indicator, such as speakers, headsets, or earbuds, for example.

Computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

Computing device 1100 may include a GPS device 1116 (or corresponding interface circuitry, as discussed above). GPS device 1116 may be in communication with a satellite-based system and may receive a location of computing device 1100, as known in the art.

Computing device 1100 may include sensor 1130 (or one or more sensors). Computing device 1100 may include corresponding interface circuitry, as discussed above. Sensor 1130 may sense physical phenomena and translate the physical phenomenon into electrical signals that can be processed by, e.g., processing device 1102. Examples of sensor 1130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1100 may include another output device 1110 (or corresponding interface circuitry, as discussed above). Examples of the other output device 1110 may include an audio codec, a video codec, a printer, a wired or wireless transmitter for providing information to other devices, haptic output device, gas output device, vibrational output device, lighting output device, home automation controller, or an additional storage device.

Computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1100 may have any desired form factor, such as a handheld or mobile computer system (e.g., a cell phone, a smartphone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or suitable networked computing component, a printer, a scanner, a monitor, a set-top box, an entertainment control unit, a vehicle control unit, a digital camera, a digital video recorder, an Internet-of-Things device, or a wearable computer system. In some examples, computing device 1100 may be any other electronic device that processes data.

### Automatic Derivation of Version Information for an Accelerator Binary Artifact

In some examples, a compiler, build system, runtime tool, firmware tool, or any combination thereof can derive version information for a binary artifact based on one or more populated task descriptors of the binary artifact. The derived version information can identify a minimum version of an execution system, such as one or more of an accelerator, accelerator hardware, accelerator firmware, accelerator driver, accelerator runtime, accelerator scheduler, or any combination thereof, that is to be used to execute at least a portion of the binary artifact. In some examples, the binary artifact may correspond to blob 172, as illustrated in FIG. 1, and the derived version information may be included in blob 172, attached to blob 172, stored separately from blob 172, or any combination thereof.

In some examples, the version information can be derived at a point in the compilation process at which no further functional change is to be made to one or more scheduled tasks, one or more task descriptors, or any combination thereof. For example, the version information may be derived by a compiler pass executed after compile-time engine 170 has populated one or more task descriptors using generated source code 160, as illustrated in FIGS. 1 and 8, and before blob 172 is finalized. Performing version derivation at such a point can allow the derived version information to reflect the final state of the one or more task descriptors used by the binary artifact.

In some examples, the version information can be derived using a hierarchy that mirrors the descriptor hierarchy described elsewhere herein. For example, a field of a task descriptor can be associated with a field version, a register of the task descriptor can be associated with a register version, the task descriptor can be associated with a descriptor version, and the binary artifact can be associated with an artifact version. In some examples, a register version can be derived based on one or more field versions associated with one or more fields of a register, a descriptor version can be derived based on one or more register versions associated with one or more registers of a task descriptor, and an artifact version can be derived based on one or more descriptor versions associated with one or more task descriptors of the binary artifact. In some examples, deriving a register, descriptor, or artifact version can comprise one or more of selecting a maximum version, selecting a minimum version, selecting a most-restrictive version, selecting a least-restrictive version, combining versions according to a precedence rule, combining versions according to a feature-compatibility rule, combining versions according to a hardware-generation rule, or any combination thereof. In some examples, the artifact version can be derived as a maximum of descriptor versions of task descriptors included in the binary artifact, a descriptor version can be derived as a maximum of register versions of registers included in a task descriptor, and a register version can be derived as a maximum of field versions of fields included in a register.

In some examples, a field version associated with a field of a task descriptor can identify a minimum version of an execution system that is to be used to interpret, process, execute, or otherwise act upon a value written into the field. In some examples, the field version can be associated with one or more of a feature, capability, operation, behavior, mode, optimization, descriptor format, register layout, encoding rule, or any combination thereof. In some examples, the field version may be encoded by descriptor definitions 150, generated source code 160, generated computer-usable code 700, reusable blueprints 360, reusable blueprint 400, or any combination thereof, as illustrated in FIGS. 1, 3, 4, and 7. For example, a generated field type may further encode one or more of a field version identifier, a minimum hardware version, a minimum runtime version, a minimum firmware version, a minimum driver version, a feature identifier, a capability identifier, or any combination thereof. In some examples, a generated register type may further identify a register version derived from one or more field versions of fields of a register, and a generated descriptor type may further identify a descriptor version derived from one or more register versions of registers of a task descriptor.

In some examples, deriving version information can comprise distinguishing used fields of a task descriptor from unused fields of the task descriptor. A used field can be a field whose value is to be interpreted, acted upon, or otherwise relied upon during execution of a corresponding task, and an unused field can be a field whose value is not to be interpreted, acted upon, or otherwise relied upon during execution of a corresponding task. In some examples, distinguishing used fields from unused fields can be performed based on one or more of a field value, a predetermined default value, a sentinel value, a placeholder value, a reserved value, a mask value, a presence indicator, a validity indicator, a metadata indicator, a descriptor-level indicator, a register-level indicator, or any combination thereof. In some examples, a field having a value equal to a predetermined default value, such as zero, may be treated as an unused field, and a field having a value not equal to the predetermined default value may be treated as a used field. In some examples, the predetermined default value may be associated with a reserved encoding, a future-use encoding, a no-operation encoding, a disabled-feature encoding, a backward-compatibility encoding, or any combination thereof. In some examples, unused fields can be excluded from version derivation such that an artifact version, descriptor version, or register version is not increased by one or more fields that are not relied upon during execution of a corresponding task.

In some examples, deriving version information for an unused field, used field, register, descriptor, or binary artifact may additionally or alternatively be performed based on one or more of an explicit usage indicator, a per-field metadata entry, a per-register metadata entry, a per-descriptor metadata entry, a per-feature metadata entry, a usage table, a usage map, a usage bitmap, a reference count, a dependency graph, or any combination thereof. In some examples, an unused field may be identified by a usage indicator that is independent of the field value, allowing nonzero values to be treated as unused when appropriate and zero values to be treated as used when appropriate. The use of a predetermined default value such as zero to identify an unused field is one example among other suitable example mechanisms for distinguishing used fields from unused fields.

In some examples, a compiler pass that derives version information can iterate over one or more task descriptors of the binary artifact, iterate over one or more registers of a task descriptor, iterate over one or more fields of a register, or any combination thereof. For a field, the compiler pass can determine whether the field is a used field or an unused field, obtain a field version associated with the field when the field is a used field, and combine the field version into a register version, descriptor version, or artifact version. For a register, the compiler pass can combine one or more field versions associated with one or more used fields of the register into a register version. For a task descriptor, the compiler pass can combine one or more register versions associated with one or more registers of the task descriptor into a descriptor version. For the binary artifact, the compiler pass can combine one or more descriptor versions associated with one or more task descriptors of the binary artifact into an artifact version. In some examples, combining versions can comprise one or more of computing a maximum, computing a minimum, computing a precedence-based selection, computing a lattice-based join, computing a lattice-based meet, computing a vendor-defined combiner function, or any combination thereof.

In some examples, the derived artifact version can be stored in, attached to, or associated with the binary artifact in one or more of a header, footer, metadata section, manifest, sidecar file, table of contents, descriptor list, version field, version register, version descriptor, or any combination thereof. In some examples, the derived artifact version can be used by one or more of a driver, runtime, firmware, scheduler, loader, or accelerator hardware to determine whether the binary artifact is to be executed, rejected, deferred, partially executed, executed in a compatibility mode, or any combination thereof. In some examples, the derived artifact version may be compared against an execution system version, such as one or more of an accelerator hardware version, accelerator firmware version, accelerator driver version, accelerator runtime version, accelerator scheduler version, or any combination thereof, to determine whether the binary artifact is compatible with the execution system.

In some examples, deriving the artifact version from the populated task descriptors at a point at which no further functional change is to be made to the populated task descriptors can reduce reliance on manual maintenance of version values during compiler development. For example, when a new feature, optimization, descriptor format, register layout, or encoding rule is added, removed, enabled, disabled, or modified in a compiler, the derived artifact version can change automatically based on the resulting populated task descriptors. This can reduce one or more of missed version updates, stale version values, incorrect version values, version values that are higher than necessary, version values that are lower than necessary, or any combination thereof, that may otherwise occur when version values are tracked explicitly throughout a compilation process.

In some examples, the techniques related to encoding version information can be combined with the descriptor layout encoding and population techniques described herein. For example, generated source code 160 may encode both layout information of one or more fields of one or more task descriptors and version information of one or more fields of the one or more task descriptors. In such examples, compile-time engine 170, as illustrated in FIG. 1, can populate one or more task descriptors using the layout information, and a compiler pass can derive an artifact version of blob 172 using the version information, the populated task descriptors, or any combination thereof. In other examples, the version derivation techniques described in this section can be used independently of the descriptor layout encoding and population techniques described elsewhere herein, and may be applied to task descriptors, hardware-consumable descriptors, command descriptors, control descriptors, data movement descriptors, packet descriptors, frame descriptors, firmware command descriptors, or any combination thereof, populated using other techniques.

### Feature-Based Compatibility Checking of a Pre-Compiled Binary Artifact

In some examples, a driver, runtime, firmware, loader, scheduler, accelerator, or any combination thereof can perform a compatibility check on a pre-compiled binary artifact prior to causing at least a portion of the pre-compiled binary artifact to be executed by an accelerator. The compatibility check can compare one or more used features associated with the pre-compiled binary artifact against one or more supported features associated with an execution system and can determine whether the pre-compiled binary artifact is compatible with the execution system based on the comparison. In some examples, the pre-compiled binary artifact may correspond to blob 172, as illustrated in FIG. 1. In some examples, the execution system may comprise one or more of accelerator hardware, accelerator firmware, an accelerator driver, an accelerator runtime, an accelerator scheduler, or any combination thereof.

In some examples, a used feature can be a feature that is used, relied upon, exercised, invoked, configured, or otherwise referenced by one or more populated task descriptors of the pre-compiled binary artifact. A supported feature can be a feature that is implemented, exposed, advertised, registered, or otherwise made available by the execution system. In some examples, a feature can correspond to one or more of an operation type, descriptor format, register layout, field encoding rule, hardware engine capability, runtime capability, driver capability, firmware capability, optimization, scheduling capability, memory transfer mode, data format, activation mode, post-processing mode, synchronization mode, control mode, or any combination thereof. In some examples, a feature can be associated with one or more compute tasks usable by compute engines 102, one or more copy tasks usable by copy engines 104, or any combination thereof, as illustrated in FIG. 1.

In some examples, the pre-compiled binary artifact can include a used-feature manifest that describes one or more used features. The used-feature manifest can comprise one or more of a list, table, sequence, array, stream, map, set, graph, metadata section, header, footer, sidecar file, descriptor section, or any combination thereof, of feature entries. In some examples, the used-feature manifest can be generated by compiler 190, as illustrated in FIG. 1, based on one or more populated task descriptors of blob 172, one or more compilation decisions, one or more scheduling decisions, one or more optimization decisions, descriptor definitions 150, target accelerator specifications 306, or any combination thereof, as illustrated in FIGS. 1 and 3. In some examples, the used-feature manifest can be derived automatically based on the populated task descriptors, such that a feature is included in the used-feature manifest when one or more populated task descriptors use the feature.

In some examples, the execution system can include a supported-feature manifest that describes one or more supported features. The supported-feature manifest can be assembled by combining one or more supported features registered by, communicated by, advertised by, or associated with one or more of accelerator hardware, accelerator firmware, an accelerator driver, an accelerator runtime, an accelerator scheduler, or any combination thereof. For example, an accelerator runtime may register one or more runtime-supported features with an accelerator driver, an accelerator hardware may register one or more hardware-supported features with the accelerator driver, and the accelerator driver may combine the registered features into a supported-feature manifest used during the compatibility check. In some examples, different accelerator hardware generations, different accelerator runtime versions, different accelerator driver versions, different accelerator firmware versions, or any combination thereof, can register different supported features.

In some examples, a feature entry of the used-feature manifest, the supported-feature manifest, or both can be represented using a self-describing data structure. The self-describing data structure can comprise one or more of a type indicator, a length indicator, a value payload, an optionality indicator, an identifier, a version indicator, a vendor indicator, a hardware-engine indicator, a descriptor-type indicator, a register-type indicator, a field-type indicator, or any combination thereof. In some examples, the self-describing data structure can comprise a type-length-value (TLV) structure, a tag-length-value structure, a key-length-value structure, an identifier-length-payload structure, a tag-value structure with explicit boundaries, or any combination thereof. In some examples, the type indicator can identify a feature, the length indicator can identify a number of bits, bytes, words, or elements of the value payload, and the value payload can comprise zero or more values associated with the feature.

In some examples, the value payload of a feature entry can carry one or more parameters, configuration values, sub-features, capability values, calibration values, mode values, dimension values, count values, threshold values, or any combination thereof, associated with the corresponding feature. By allowing a feature entry to carry an arbitrary value payload, the self-describing data structure can support features that are not adequately represented by a Boolean flag, a fixed-width bitmap, a fixed-schema field, or a predefined profile. For example, a multi-threading feature may carry a value payload identifying a number of threads, a tiling feature may carry a value payload identifying one or more tile dimensions, a precision feature may carry a value payload identifying one or more numeric formats, and a memory transfer feature may carry a value payload identifying one or more transfer modes.

In some examples, the optionality indicator associated with a feature entry can identify the corresponding feature as one or more of required, optional, recommended, deprecated, conditional, vendor-specific, or any combination thereof. A required feature can be a feature that is to be supported by the execution system for the pre-compiled binary artifact to be considered compatible. An optional feature can be a feature that is not required to be supported by the execution system for the pre-compiled binary artifact to be considered compatible. In some examples, the optionality indicator can be encoded separately from the type indicator, the length indicator, and the value payload, such that a recipient of the feature entry can determine the optionality of the corresponding feature independently of any knowledge of the corresponding feature.

In some examples, by encoding optionality separately from feature identity, the self-describing data structure can support forward compatibility, backward compatibility, or both. For example, a driver, runtime, or firmware that does not recognize a feature identified by a type indicator of a feature entry can use the optionality indicator and the length indicator to determine how to process the feature entry. When the feature entry is marked as optional, the driver, runtime, or firmware can skip the feature entry using the length indicator and continue processing one or more subsequent feature entries. When the feature entry is marked as required, the driver, runtime, or firmware can treat the pre-compiled binary artifact as incompatible. In some examples, this can allow newer pre-compiled binary artifacts that include unknown features to be executed by older execution systems when the unknown features are optional, and to be rejected by older execution systems when the unknown features are required.

In some examples, the compatibility check can comprise one or more of a used-feature recognition operation, a used-feature validation operation, a required-feature presence operation, or any combination thereof. In a used-feature recognition operation, the execution system can determine, for each used feature identified in the used-feature manifest of the pre-compiled binary artifact, whether the used feature is registered by, advertised by, or otherwise associated with the execution system. In some examples, when a used feature is not registered, the execution system can treat the pre-compiled binary artifact as incompatible. In some examples, this can be performed regardless of optionality, because validity of a used feature that is not recognized may not be confirmable by the execution system.

In a used-feature validation operation, the execution system can validate one or more used features that are registered using a validation function, validation routine, validation rule, validation predicate, validation table, validation schema, or any combination thereof, associated with the used feature. In some examples, the validation function can be provided by one or more of accelerator hardware, accelerator firmware, an accelerator driver, an accelerator runtime, an accelerator scheduler, or any combination thereof. The validation function can examine the value payload, type indicator, length indicator, optionality indicator, or any combination thereof, of the corresponding feature entry, and can determine whether the corresponding feature, as configured by the value payload, is supported by the execution system. In some examples, validation functions for different features can examine different portions of the corresponding feature entries, apply different rules, and produce independent results. By delegating per-feature validation to per-feature validation functions, the execution system can extend compatibility checking to support new features without modifying a shared validation schema.

In a required-feature presence operation, the execution system can determine, for each feature registered by the execution system as required, whether the required feature is present in the used-feature manifest of the pre-compiled binary artifact. In some examples, when a feature registered as required is not present in the used-feature manifest, the execution system can treat the pre-compiled binary artifact as incompatible. In some examples, a feature may be registered as required by the execution system when the execution system relies on the feature for one or more of correctness, safety, security, performance guarantees, regulatory requirements, or any combination thereof.

In some examples, the compatibility check can be performed at one or more points in the lifecycle of the pre-compiled binary artifact, including one or more of a build time, a model compile time, a packaging time, a distribution time, an installation time, a load time, an initialization time, a pre-inference time, a per-task time, or any combination thereof. In some examples, the compatibility check can be performed before any task descriptor of the pre-compiled binary artifact is scheduled for execution by an accelerator. In some examples, the compatibility check can be performed by a driver upon loading the pre-compiled binary artifact, before causing one or more populated task descriptors of the pre-compiled binary artifact to be provided to one or more hardware engines of the accelerator.

In some examples, the compatibility check can produce one or more of a compatibility result, an incompatibility result, a diagnostic message, an error code, a list of unsupported features, a list of missing required features, a list of validation failures, or any combination thereof. In some examples, when the pre-compiled binary artifact is determined to be incompatible, the execution system can refrain from causing the pre-compiled binary artifact to be executed by the accelerator, can communicate a diagnostic to a user application, can communicate a diagnostic to a developer tool, can communicate a diagnostic to a logging system, can suggest one or more remediation actions, or any combination thereof.

In some examples, encoding used features and supported features using a self-describing data structure with explicit optionality can support fine-grained compatibility decisions across versions of one or more of an accelerator, accelerator firmware, accelerator driver, accelerator runtime, accelerator scheduler, or any combination thereof. For example, a newer version of an accelerator driver can deprecate a feature by removing the feature from the supported-feature manifest, and pre-compiled binary artifacts that do not use the deprecated feature can remain compatible with the newer version of the accelerator driver, while pre-compiled binary artifacts that use the deprecated feature can be rejected by the newer version of the accelerator driver. In some examples, this can allow a subset of pre-compiled binary artifacts to be invalidated by a change in the execution system without invalidating other pre-compiled binary artifacts that do not rely on the changed feature.

In some examples, the feature-based compatibility checking techniques can be combined with the descriptor layout encoding and population techniques described herein. For example, generated source code 160 may encode layout information of one or more fields of one or more task descriptors and may further encode an association between one or more fields and one or more features. In such examples, a used-feature manifest of blob 172 can be generated based on one or more populated task descriptors of blob 172 and the encoded feature associations. In other examples, the feature-based compatibility checking techniques described in this section can be used independently of the descriptor layout encoding and population techniques described elsewhere herein, and can be applied to pre-compiled binary artifacts, firmware-consumable artifacts, accelerator-consumable artifacts, command streams, or any combination thereof, produced using other techniques. In some examples, the feature-based compatibility checking techniques described in this section can additionally or alternatively be combined with the version derivation techniques described elsewhere herein, such that an artifact version derived from one or more populated task descriptors is included in, combined with, or used in addition to a used-feature manifest of the pre-compiled binary artifact.

### Select Examples

Example 1 provides one or more non-transitory computer-readable media storing instructions, that, when executed by one or more processors, cause the one or more processors to perform operations including generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and populating, using the generated computer-usable code, a task descriptor for a scheduled task in a memory location by writing, to the memory location, one or more values into one or more fields of the task descriptor according to the layout information encoded by the generated computer-usable code.

Example 2 provides the one or more non-transitory computer-readable media of example 1, where populating the task descriptor includes writing the one or more values into the one or more fields without performing, during the populating, a lookup operation to determine where the one or more values are to be written in the task descriptor.

Example 3 provides the one or more non-transitory computer-readable media of example 1 or 2, where the layout information encoded by the generated computer-usable code includes, for a field of the one or more fields, one or more of a bit offset, a byte offset, a field width, a field type, and a register identifier.

Example 4 provides the one or more non-transitory computer-readable media of any one of examples 1-3, where the generated computer-usable code includes one or more generated data types corresponding to at least one of a descriptor type, a register type, or a field type of the one or more task descriptors.

Example 5 provides the one or more non-transitory computer-readable media of any one of examples 1-4, where populating the task descriptor includes invoking a write function parameterized by a descriptor type and a field type.

Example 6 provides the one or more non-transitory computer-readable media of any one of examples 1-5, where populating the task descriptor includes invoking a write function that includes a compile-time check that verifies that a field type is associated with a descriptor type.

Example 7 provides the one or more non-transitory computer-readable media of any one of examples 1-6, where the one or more descriptor definitions define a hierarchy in which a given task descriptor includes one or more registers and a register of the one or more registers includes a plurality of fields.

Example 8 provides the one or more non-transitory computer-readable media of any one of examples 1-7, where writing the one or more values includes determining, based on the layout information encoded by the generated computer-usable code, a storage word and a bit position corresponding to a field of the task descriptor; and updating one or more bits of the storage word corresponding to the field.

Example 9 provides the one or more non-transitory computer-readable media of any one of examples 1-8, where the one or more task descriptors include one or more compute task descriptors for a compute engine of the accelerator; and one or more copy task descriptors for a copy engine of the accelerator.

Example 10 provides the one or more non-transitory computer-readable media of any one of examples 1-9, where: the one or more descriptor definitions identify a descriptor layout associated with a particular accelerator configuration; and the generated computer-usable code encodes the descriptor layout associated with the particular accelerator configuration.

Example 11 provides the one or more non-transitory computer-readable media of example 10, where the descriptor layout associated with the particular accelerator configuration is selected from a plurality of descriptor layouts associated with different accelerator configurations before generating the computer-usable code.

Example 12 provides the one or more non-transitory computer-readable media of any one of examples 1-11, where the operations further include generating a binary artifact including the task descriptor populated using the generated computer-usable code, the binary artifact for the accelerator to perform at least a portion of the neural network execution.

Example 13 provides a computer system including one or more processors; and one or more non-transitory computer-readable media storing instructions that, when executed by the one or more processors, cause the computer system to perform operations including generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and populating, using the generated computer-usable code, a task descriptor for a scheduled task in a memory location by writing, to the memory location, one or more values into one or more fields of the task descriptor according to the layout information encoded by the generated computer-usable code.

Example 14 provides the computer system of example 13, where populating the task descriptor includes writing the one or more values into the one or more fields without performing, during the populating, a lookup operation to determine where the one or more values are to be written in the task descriptor.

Example 15 provides the computer system of example 13 or 14, where the layout information encoded by the generated computer-usable code includes, for a field of the one or more fields, one or more of a bit offset, a byte offset, a field width, a field type, and a register identifier.

Example 16 provides the computer system of any one of examples 13-15, where the generated computer-usable code includes one or more generated data types corresponding to at least one of a descriptor type, a register type, or a field type of the one or more task descriptors.

Example 17 provides the computer system of any one of examples 13-16, where populating the task descriptor includes invoking a write function parameterized by a descriptor type and a field type.

Example 18 provides the computer system of any one of examples 13-17, where populating the task descriptor includes invoking a write function that includes a compile-time check that verifies that a field type is associated with a descriptor type.

Example 19 provides the computer system of any one of examples 13-18, where the one or more descriptor definitions define a hierarchy in which a given task descriptor includes one or more registers and a register of the one or more registers includes a plurality of fields.

Example 20 provides the computer system of any one of examples 13-19, where writing the one or more values includes determining, based on the layout information encoded by the generated computer-usable code, a storage word and a bit position corresponding to a field of the task descriptor; and updating one or more bits of the storage word corresponding to the field.

Example 21 provides the computer system of any one of examples 13-20, where the one or more task descriptors include one or more compute task descriptors for a compute engine of the accelerator; and one or more copy task descriptors for a copy engine of the accelerator.

Example 22 provides the computer system of any one of examples 13-21, where: the one or more descriptor definitions identify a descriptor layout associated with a particular accelerator configuration; and the generated computer-usable code encodes the descriptor layout associated with the particular accelerator configuration.

Example 23 provides the computer system of example 22, where the descriptor layout associated with the particular accelerator configuration is selected from a plurality of descriptor layouts associated with different accelerator configurations before generating the computer-usable code.

Example 24 provides the computer system of any one of examples 13-23, where the operations further include generating a binary artifact including the task descriptor populated using the generated computer-usable code, the binary artifact being for the accelerator to perform at least a portion of the neural network execution.

Example 25 provides a method, including generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and populating, using the generated computer-usable code, a task descriptor for a scheduled task in a memory location by writing, to the memory location, one or more values into one or more fields of the task descriptor according to the layout information encoded by the generated computer-usable code.

Example 26 provides the method of example 25, where populating the task descriptor includes writing the one or more values into the one or more fields without performing, during the populating, a lookup operation to determine where the one or more values are to be written in the task descriptor.

Example 27 provides the method of example 25 or 26, where the layout information encoded by the generated computer-usable code includes, for a field of the one or more fields, one or more of a bit offset, a byte offset, a field width, a field type, and a register identifier.

Example 28 provides the method of any one of examples 25-27, where the generated computer-usable code includes one or more generated data types corresponding to at least one of a descriptor type, a register type, or a field type of the one or more task descriptors.

Example 29 provides the method of any one of examples 25-28, where populating the task descriptor includes invoking a write function parameterized by a descriptor type and a field type.

Example 30 provides the method of any one of examples 25-29, where populating the task descriptor includes invoking a write function that includes a compile-time check that verifies that a field type is associated with a descriptor type.

Example 31 provides the method of any one of examples 25-30, where the one or more descriptor definitions define a hierarchy in which a given task descriptor includes one or more registers and a register of the one or more registers includes a plurality of fields.

Example 32 provides the method of any one of examples 25-31, where writing the one or more values includes determining, based on the layout information encoded by the generated computer-usable code, a storage word and a bit position corresponding to a field of the task descriptor; and updating one or more bits of the storage word corresponding to the field.

Example 33 provides the method of any one of examples 25-32, where the one or more task descriptors include one or more compute task descriptors for a compute engine of the accelerator; and one or more copy task descriptors for a copy engine of the accelerator.

Example 34 provides the method of any one of examples 25-33, where: the one or more descriptor definitions identify a descriptor layout associated with a particular accelerator configuration; and the generated computer-usable code encodes the descriptor layout associated with the particular accelerator configuration.

Example 35 provides the method of example 34, where the descriptor layout associated with the particular accelerator configuration is selected from a plurality of descriptor layouts associated with different accelerator configurations before generating the computer-usable code.

Example 36 provides the method of any one of examples 25-35, further including generating a binary artifact including the task descriptor populated using the generated computer-usable code, the binary artifact being for the accelerator to perform at least a portion of the neural network execution.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. One or more non-transitory computer-readable media storing instructions, that, when executed by one or more processors, cause the one or more processors to perform operations comprising:
generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and
populating, using the generated computer-usable code, a task descriptor for a scheduled task in a memory location by writing, to the memory location, one or more values into one or more fields of the task descriptor according to the layout information encoded by the generated computer-usable code.

2. The one or more non-transitory computer-readable media of claim 1, wherein populating the task descriptor comprises:
writing the one or more values into the one or more fields without performing, during the populating, a lookup operation to determine where the one or more values are to be written in the task descriptor.

3. The one or more non-transitory computer-readable media of claim 1, wherein the layout information encoded by the generated computer-usable code comprises, for a field of the one or more fields, one or more of a bit offset, a byte offset, a field width, a field type, and a register identifier.

4. The one or more non-transitory computer-readable media of claim 1, wherein the generated computer-usable code comprises one or more generated data types corresponding to at least one of a descriptor type, a register type, or a field type of the one or more task descriptors.

5. The one or more non-transitory computer-readable media of claim 1, wherein populating the task descriptor comprises:
invoking a write function parameterized by a descriptor type and a field type.

6. The one or more non-transitory computer-readable media of claim 1, wherein populating the task descriptor comprises:
invoking a write function that includes a compile-time check that verifies that a field type is associated with a descriptor type.

7. The one or more non-transitory computer-readable media of claim 1, wherein the one or more descriptor definitions define a hierarchy in which a given task descriptor includes one or more registers and a register of the one or more registers includes a plurality of fields.

8. The one or more non-transitory computer-readable media of claim 1, wherein writing the one or more values comprises:
determining, based on the layout information encoded by the generated computer-usable code, a storage word and a bit position corresponding to a field of the task descriptor; and
updating one or more bits of the storage word corresponding to the field.

9. The one or more non-transitory computer-readable media of claim 1, wherein the one or more task descriptors comprise:
one or more compute task descriptors for a compute engine of the accelerator; and
one or more copy task descriptors for a copy engine of the accelerator.

10. The one or more non-transitory computer-readable media of claim 1, wherein:
the one or more descriptor definitions identify a descriptor layout associated with a particular accelerator configuration; and
the generated computer-usable code encodes the descriptor layout associated with the particular accelerator configuration.

11. The one or more non-transitory computer-readable media of claim 10, wherein the descriptor layout associated with the particular accelerator configuration is selected from a plurality of descriptor layouts associated with different accelerator configurations before generating the computer-usable code.

12. The one or more non-transitory computer-readable media of claim 1, wherein the operations further comprise:
generating a binary artifact comprising the task descriptor populated using the generated computer-usable code, the binary artifact for the accelerator to perform at least a portion of the neural network execution.

13. A computer system comprising:
one or more processors; and
one or more non-transitory computer-readable media storing instructions that, when executed by the one or more processors, cause the computer system to perform operations comprising:
generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and
populating, using the generated computer-usable code, a task descriptor for a scheduled task in a memory location by writing, to the memory location, one or more values into one or more fields of the task descriptor according to the layout information encoded by the generated computer-usable code.

14. The computer system of claim 13, wherein populating the task descriptor comprises:
writing the one or more values into the one or more fields without performing, during the populating, a lookup operation to determine where the one or more values are to be written in the task descriptor.

15. The computer system of claim 13, wherein the layout information encoded by the generated computer-usable code comprises, for a field of the one or more fields, one or more of a bit offset, a byte offset, a field width, a field type, and a register identifier.

16. The computer system of claim 13, wherein the generated computer-usable code comprises one or more generated data types corresponding to at least one of a descriptor type, a register type, or a field type of the one or more task descriptors.

17. The computer system of claim 13, wherein populating the task descriptor comprises:
invoking a write function parameterized by a descriptor type and a field type.

18. The computer system of claim 13, wherein populating the task descriptor comprises:
invoking a write function that includes a compile-time check that verifies that a field type is associated with a descriptor type.

19. A method, comprising:
generating, based on one or more descriptor definitions for one or more task descriptors for an accelerator, computer-usable code that encodes layout information of one or more fields of the one or more task descriptors, the accelerator having one or more hardware engines to perform one or more tasks associated with a neural network execution; and
populating, using the generated computer-usable code, a task descriptor for a scheduled task in a memory location by writing, to the memory location, one or more values into one or more fields of the task descriptor according to the layout information encoded by the generated computer-usable code.

20. The method of claim 19, wherein populating the task descriptor comprises:
writing the one or more values into the one or more fields without performing, during the populating, a lookup operation to determine where the one or more values are to be written in the task descriptor.
